(19) United States
(12) Patent Application Publication
(10) Pub. No.: US 2012/0183794 A1
(43) Pub. Date: Jul. 19, 2012

(54) WHEY-PROTEIN BASED ENVIRONMENTALLY FRIENDLY WOOD ADHESIVES AND METHODS OF PRODUCING AND USING THE SAME

(75) Inventors: Mingruo Guo, South Burlington, VT (US); Michael E. Vayda, South Burlington, VT (US); Zhenhua Gao, Harbin (CN)

(73) Assignee: The University of Vermont and State Agricultural College, Burlington, VT (US)

(21) Appl. No.: 13/263,933

(22) PCT Filed: Apr. 13, 2010
(86) PCT No.: PCT/US10/01088

§ 371 Date: Apr. 4, 2012

Related U.S. Application Data
(60) Provisional application No. 61/212,633, filed on Apr. 13, 2009.

(51) Int. Cl. B32B 21/04; C09J 189/00

(52) U.S. Cl. 428/479.6; 524/17; 523/122

(57) ABSTRACT

Wood adhesives and methods of production and application of wood adhesives are provided. The adhesives may contain proteins, and specifically may include whey proteins derived from dairy processing. Products utilizing whey-based wood adhesives are also provided as are paper adhesives that include whey protein.

### RELATED APPLICATIONS

This application claims benefit under 35 U.S.C. §119(e) of U.S. Provisional Application No. 61/212,633, filed Apr. 13, 2009, the content of which is incorporated by reference herein in its entirety.

### GOVERNMENT SUPPORT

This invention is at least in part the result of work that was supported by the United States Department of Agriculture Grants (011452 and 022434). The government has certain rights in this invention.

### FIELD OF THE INVENTION

The invention relates to wood and paper adhesives containing naturally occurring products and, more specifically, to wood, plywood and paper adhesives containing proteins.

### BACKGROUND OF THE INVENTION

Renewable bio-based materials are drawing more attention for obtaining chemical resources due to the decrease in availability and cost of non-renewable fossil resources. Therefore, many countries have focused on the bio-based resources to obtain biomass energy, chemicals and building materials, or to create substitutes for petroleum-based materials to the greatest extent possible.

The dairy industry produces large amounts of whey as a byproduct in the production of cheese and other dairy products. Whey can include protein, fats, and carbohydrates such as lactose. About 9 L of whey is generated for every kilogram of cheese manufactured and about 90.5 billion pounds of whey was estimated to be generated in USA in 2008 according to the Annual Summary of Dairy Products, USDA National Agricultural Statistics Service. However, more than 30% of the whey is disposed to the environment in the US. This disposal can lead to significant environmental problems due to the increase in biological oxygen demand (BOD) released into the environment when the whey is disposed of. Thus, there is an increasing economical and environmental need for finding new applications for whey proteins.

Some limited uses for whey have been developed. For example, whey proteins can be used in photographic emulsions, and a saponified whey protein, at an elevated pH, can be used to protect the lignin component of wood shavings from attack by pests. The wood shavings can then be used as heat insulation in construction (U.S. Pat. No. 5,476,636). Whey proteins are also being gradually used in food and non-food applications, e.g., as a food ingredient, for preparations of protective films, paper coatings, surfactants in hair creams and shampoos, pharmacology, biotechnological reagents, etc. However, this valuable fraction of cheese whey is still not fully utilized.

### SUMMARY OF THE INVENTION

The invention relates, in part, to environmentally whey-protein based adhesives and glues which provide good bonding strength, bond durability, water-resistance, low cost and are low- or non-toxic. Aspects of the invention also relate to methods of production and application of whey-protein based adhesives.

According to one aspect of the invention, a wood adhesive solution which includes whey protein, water, a crosslinking agent, and a plasticizer is provided. In some embodiments, the crosslinking agent is a multifunctional isocyanate, a polyisocyanate, a pre-polymer of polyisocyanate, polyvinyl alcohol (PVA), an ethylene-vinyl alcohol, polyvinyl formal, polyvinyl butyral, or a combination thereof. In some embodiments, the crosslinking agent is a multifunctional isocyanate, a polyisocyanate, a pre-polymer of polyisocyanate, or a combination thereof. In certain embodiments, the polyisocyanate is polymeric methylene diphenyl diisocyanate (MDI). In some embodiments, the crosslinking agent is polyvinyl alcohol (PVA), an ethylene-vinyl alcohol, polyvinyl formal, polyvinyl butyral, or a combination thereof. In some embodiments, the an ethylene-vinyl alcohol (EVAOH) copolymer has 25% or more vinyl alcohol units. In some embodiments, the plasticizer is polyvinyl acetate emulsion, an ethylene-vinyl acetate (EVA) emulsion, an ethylene-vinyl alcohol (EVAOH) emulsion, a styrene-butadiene (SB) emulsion, a styrene-butadiene-styrene (SB) emulsion, other latexes, or a combination thereof. In some embodiments, the wood adhesive solution includes between 5-50% by weight of whey protein. In some embodiments, the wood adhesive solution includes between 5-50% by weight of the plasticizer. In some embodiments, the wood adhesive solution includes between 1-20% by weight of the crosslinking agent. In certain embodiments, the wood adhesive solution includes between 1-30% by weight of the crosslinking agent. In some embodiments, the whey protein is denatured whey protein. In some embodiments, the whey protein is thermally denatured. In some embodiments, the pH of the wood adhesive solution is from 3 to 10. In some embodiments, the viscosity of the wood adhesive solution is between 100-1000 mPa at 20° C. In some embodiments, the wood adhesive solution has a dry bond strength of at least 8.5 MPa. In certain embodiments, the dry bond strength is at least 10 MPa, 10.5 MPa, 11.0 MPa, 11.5 MPa, 12 MPa, 12.5 MPa, 13 MPa, 13.5 MPa, 14 MPa, 14.5 MPa. In some embodiments, the wood adhesive solution attains a wet strength of up to 6.8 MPa when soaked in 57-63° C. water for three hours (WS3h). In certain embodiments, the wood adhesive solution attains a wet strength of at least 5.65 MPa when boiled for 4 hours and dried for 20 hours and then boiled for 4 hours (WS28h).

In some embodiments, the wood adhesive solution also includes one or more of a filler, a pigment agent, a stabilizing agent, a defoamer, a pH-adjusting agent, a solvent, a flame retardant, a biocide, an antimicrobial agent, or a scent agent. In certain embodiments, the filler is calcium carbonate (CaCO₃). In some embodiments, the defoamer is a polysiloxane solution. In some embodiments, the wood adhesive solution also includes 0.01-0.1% by weight formic acid or 0.01-0.5% by weight sodium formic. In some embodiments, the wood adhesive solution is disposed on a surface. In certain embodiments, the surface is wood. In some embodiments, the wood adhesive solution is disposed between two surfaces, wherein the solution, when dry, forms a bond between the surfaces. In certain embodiments, at least one of the two surfaces is wood. In some embodiments, the dry bond strength of the bond is at least 10 MPa, 10.5 MPa, 11.0 MPa, 11.5 MPa, 12 MPa, 12.5 Mpa, 13 MPa, 13.5 MPa, 14 MPa, or 14.5 MPa. In some embodiments, the wood adhesive solution is clear when dry. In certain embodiments, the wood adhesive solution is opaque or colored when dry.

According to another aspect of the invention, methods of applying the wood adhesive solution to a surface are provided. In some embodiments, the wood adhesive solution is applied to the surface by brushing, pouring, spraying, rolling, or dipping.

According to yet another aspect of the invention, a process for preparing a whey protein isolate (WPI) solution is provided. The process includes preparing a WPI solution having between 10-40% by weight whey protein by: (a) contacting WPI with water at a temperature between 35-55° with agitation to make a WPI solution; and (b) maintaining the WPI solution between 35-55° C. with at least occasional agitation for a period of time between 5 and 60 minutes. In some embodiments, the process also includes (c) cooling and maintaining the WPI solution at 2-25° C. In certain embodiments, the process also includes adding 0.01-0.1% by weight formic acid or 0.01-0.5% by weight sodium formic. In certain embodiments, the water in step (a) of the process is at a temperature between 40 and 49° C. In some embodiments, the WPI/water solution is maintained in step (b) of the process between 45-49° C. for between 30-45 minutes. In certain embodiments, the process also includes adding 0.01-0.5 weight percent defoamer to the WPI solution. In certain embodiments, the defoamer is polysiloxane solution such as BYK®-025.

In some embodiments, the process also includes (c) increasing the temperature of the WPI solution to between 40 and 80° C. with at least occasional agitation; (d) contacting the heated WPI solution with a crosslinking agent; and (e) maintaining the WPI/crosslinking agent solution between 40 and 80° C. with heating for 5-65 minutes with at least occasional agitation. In some embodiments, the WPI/crosslinking agent solution is maintained in (e) at between 55-65° C. for 15-55 minutes. In certain embodiments, the WPI/crosslinking agent solution maintained in (e) at between 55-65° C. for 5-15 minutes. In some embodiments, the crosslinking agent is polyvinyl alcohol (PVA), an ethylene-vinyl alcohol, polyvinyl formal, polyvinyl butyral, or a combination thereof.

According to yet another aspect of the invention, a method of making a wood adhesive solution is provided. The method includes mixing a denatured whey protein with a crosslinking agent and a plasticizer to produce a wood adhesive solution. In some embodiments, the wood adhesive solution includes 10-40%, 20-40%, or 30-40% (w/v) denatured whey protein. In certain embodiments, the wood adhesive solution comprises 5-50%, 10-40%, or 20-30% (w/v) whey-protein isolate (WPI) solution. In some embodiments, the denatured whey protein is the denatured WPI prepared using the processes as described elsewhere in the application. In some embodiments, the wood adhesive solution includes 5-50%, 10-40%, 10-30%, or 10-20% (w/v) of the plasticizer. In certain embodiments, the plasticizer is polyvinyl acetate emulsion, an ethylene-vinyl acetate (EVA) emulsion, an ethylene-vinyl alcohol (EVAOH) emulsion, a styrene-butadiene (SB) emulsion, a styrene-butadiene-styrene (SB) emulsion, other latexes, or a combination thereof. In some embodiments, the wood adhesive solution includes 1-30%, 1-20%, 1-10%, or 1-5% (w/v) of a crosslinking agent. In certain embodiments, the crosslinking agent is a multifunctional isocyanate, a polyisocyanate, a pre-polymer of polyisocyanate, polyvinyl alcohol (PVA), an ethylene-vinyl alcohol, polyvinyl formal, polyvinyl butyral or a combination thereof. In some embodiments, the solid content of the wood adhesive solution is not less than 30% (w/v) of the solution. In certain embodiments, the crosslinking agent is first mixed with the plasticizer, followed by addition to and mixing with the denatured whey protein. In some embodiments, the method also includes adding one or more of a biocide, an antimicrobial, a pigment agent, a scent agent, a filler, a pH control agent, or a stabilizing agent. In some embodiments, the filler is calcium carbonate (CaCO₃). In some embodiments, the wood adhesive solution includes 0.1-20% CaCO₃. In certain embodiments, the CaCO₃ is added to the wood adhesive solution with at least occasional agitation.

According to yet another aspect of the invention, a paper glue solution which includes a crosslinking agent, a milk protein, and water is provided. In some embodiments, the crosslinking agent and the milk protein are present in the solution in a ratio of at least 1.1 to 0.1. In some embodiments, the crosslinking agent is a multifunctional isocyanate, a polyisocyanate, a pre-polymer of polyisocyanate, polyvinyl alcohol (PVA), ethylene-vinyl alcohol, polyvinyl formal, polyvinyl butyral, polyvinyl acetate, ethylene-vinyl acetate (EVA), ethylene-vinyl alcohol (EVAOH), styrene-butadiene (SB), a styrene-butadiene-styrene (SB), another latex, or a combination thereof. In some embodiments, the milk protein is whey protein, casein, or a combination thereof. In certain embodiments, the milk protein is polymerized milk protein. In some embodiments, the pH of the paper glue solution is between 3 and 10. In certain embodiments, the pH of the solution is about 5 and 8. In some embodiments, the viscosity of the paper glue solution is between 300-1000 mPa at 20° C. In certain embodiments, the paper glue solution, when dry, has a dry bond strength of at least 150N. In certain embodiments, the paper glue solution has an ash content of less than 0.25% (w/v). In some embodiments, the paper glue solution has a protein content of at least 5% (w/v). In certain embodiments, the paper glue solution includes a total solid content of at least 20% w/v. In some embodiments, the paper glue solution also includes one or more of a solidifier, moisturizer, adhesive enhancer, organic and/or inorganic filler, binder, emulsifier, pigment agent, stabilizing agent, defoamer, pH-adjusting agent, solvent, biocide, antimicrobial agent, or scent agent. In some embodiments, the moisturizer is propylene glycol. In some embodiments, the antibacterial agent is 1,2-Benzisothiazolin-3-one. In some embodiments, the solidifier is sodium stearate. In some embodiments, the adhesive enhancer is nano calcium carbonate. In some embodiments, the paper glue solution is applied to a surface.

According to yet another aspect of the invention, a method of making a paper glue solution is provided. The method includes contacting a milk protein with water and a crosslinking agent to produce a paper glue solution. In some embodiments, the milk protein is whey protein, casein, or a combination thereof. In certain embodiments, the milk protein is thermally polymerized. In some embodiments, the method also includes adding one or more of an emulsifier, a filler, a pigment agent, a stabilizing agent, a defoamer, a pH-adjusting agent, a solvent, a flame retardant, a biocide, an antimicrobial agent, an anti-bacterial agent, or a scent agent.

According to yet another aspect of the invention, a plywood adhesive solution that includes whey protein, water, and a modifier species is provided. The plywood adhesive solution is water resistant when dry. In some embodiments, the modifier species is a multifunctional isocyanate, a polyisocyanate, a pre-polymer of polyisocyanate, polyvinyl alcohol (PVA), an ethylene-vinyl alcohol, polyvinyl formal, polyvinyl butyral, a dialdehyde, or a combination thereof. In some embodiments, the polyisocyanate is polymeric methylene diphenyl diisocyanate (MDI). In certain embodiments, the dialdehyde is glutaraldehyde, glyoxal, or a combination thereof. In some embodiments, the plywood adhesive solution is disposed between two or more plywood panels, wherein the solution when dry, forms a bond between the panels. In some embodiments, the plywood adhesive solution also includes one or more of a filler, a pigment agent, a stabilizing agent, a defoamer, a pH-adjusting agent, a solvent, a flame retardant, a biocide, an antimicrobial agent, or a scent agent. In some embodiments, the plywood adhesive solution, when dry, has a dry bond strength of at least 1.0 MPa. In some embodiments, the plywood adhesive solution has a wet strength of at least 1.0 MPa after boiling and drying (WS28h).

According to yet another aspect of the invention, a method of making a plywood adhesive solution is provided. The method includes contacting whey protein, water, and a modifier species to produce a plywood adhesive solution that is water-resistant when dry. In some embodiments, the modifier species is a multifunctional isocyanate, a polyisocyanate, a pre-polymer of polyisocyanate, polyvinyl alcohol (PVA), an ethylene-vinyl alcohol, polyvinyl formal, polyvinyl butyral, a dialdehyde, or a combination thereof. In some embodiments, the polyisocyanate is polymeric methylene diphenyl diisocyanate (MDI). In some embodiments, the dialdehyde is glutaraldehyde, glyoxal, or a combination thereof. In some embodiments, the method also includes adding one of more of a filler, a pigment agent, a stabilizing agent, a defoamer, a pH-adjusting agent, a solvent, a flame retardant, a biocide, an antimicrobial agent, or a scent agent.

According to yet another aspect of the invention, a method of applying the plywood adhesive solution to a surface is provided. The method includes applying the plywood adhesive solution to the surface by brushing, spraying, rolling or dipping.

According to yet another aspect of the invention, a wood laminate comprising wood panels bonded together by a plywood adhesive solution is provided.

According to yet another aspect of the invention, kits are provided. In some embodiments, the kits include a container of wood adhesive solution; and instructions for applying the wood adhesive solution to a wood surface wherein the wood adhesive solution comprises whey protein. In some embodiments, the whey protein is denatured. In some embodiments, the whey protein comprises WPI. In some embodiments, the wood adhesive solution is a plywood adhesive solution. In some embodiments, the kits include a container of a paper adhesive solution; and instructions for applying the paper adhesive solution to a wood surface wherein the paper adhesive solution comprises whey protein. In some embodiments, the whey protein is denatured.

Other aspects, embodiments, and features of the invention will become apparent from the following detailed description. All references incorporated herein are incorporated in their entirety. In cases of conflict between an incorporated reference and the present specification, the present specification shall control.

### BRIEF DESCRIPTION OF THE DRAWINGS

FIG. 1: provides an image of IR spectra of whey-protein based API adhesives and cured resultants. Trace a is whey protein isolate (WPI) only; b is WPI/PVA; c is WPI/MDI; d is WPI/PVAc/MDI; e is WPI/PVA/PVAc/MDI; and f is PVA/MDI.

FIG. 2: shows scanning electron microscope (SEM) photos of cured whey-protein based API adhesives with FIG. 2a: WPI/MDI; FIG. 2b: WPI/PVAc/MDI; FIG. 2c: WPI/PVA/PVAc/MDI; and FIG. 2d: WPUPVA/PVAc/nano-CaCO₃/MDI.

FIG. 3: provides illustrations of dominant reactions in whey-protein based API adhesive.

FIG. 4: provides images of Fourier transform infrared spectroscopy (FTIR) spectra of water base glues and the cured resultants of for whey-protein based API adhesives.

FIG. 5: provides SEM micrographs of various fresh adhesives after frozen by liquid nitrogen and then freeze dried; FIG. 5A: PVAc only; FIG. 5B: WPI/PVA blend; FIG. 5C: Blended WPUPVA with PVAc; FIG. 5D: Blended PVAc with MDI; FIG. 5E: Blended WPI/PVA with PVAc before blending with MDI; and FIG. 5F: Blended PVAc with MDI before blending with WPI/PVA.

FIG. 6: provides a bar graph indicating the effect of whey protein denaturation temperature on bonding strength.

FIG. 7: provides a line graph indicating the effect of PVAC on bonding strength of glue sticks. For P=0.000<0.01, the effect is very significant. Pair comparison: 100 g VS 300 g, p=0.000 Very significant; 100 g VS 200 g, p=0.004 Very significant; 200 g VS 300 g, p=0.058, no significant difference

FIG. 8: provides a line graph indicating the effect of sodium stearate on bonding strength of glue sticks. For P=0.049<0.05, the effect is close to significant. Pair comparison: 70 g VS 60 g, p=0.782 no significant difference; 70 g VS 50 g, p=0.044 Significant; 60 g VS 50 g, p=0.025, significant difference

FIG. 9: provides a line graph indicating the effect of PVOH on bonding strength of glue sticks. P=0.001<0.01, the effect is very significant. Pair comparison: 300 g VS 400 g, p=0.000 very significant difference; 300 g VS 500 g, p=0.005 Very significant difference; 400 g VS 500 g, p=0.215, no significant difference

FIG. 10: provides a line graph indicating the effect of WPI solution concentration on bonding strength of glue sticks. P=0.009<0.01, the effect is very significant. Pair comparison: 0% VS 5%, p=0.014 very significant difference; 0% VS 10%, p=0.004 Very significant difference 5% VS 10%, p=0.529, no significant difference

FIG. 11: provides a line graph indicating the effect of PG on bonding strength of glue sticks. P=0.558>0.05. The amount of PG in the formulation has no significant effect on the bonding strength.

FIG. 12: provides a bar graph indicating the effect of PVAC/sodium caseinate as co-binder on bonding strength of glue sticks. The 5 formulations do not all have similar means (p=0.015). Commercial glue stick and S1 (300 g PVAC) are significantly higher than S2 and S4. S3 is not significantly different from any others.

FIG. 13: provides a bar graph indicating the effect of high speed blending technology on bonding strength of glue sticks. P=0.026<0.05. The bonding strength of glue stick made by high speed blending technology is significant higher than that of regular blending technology.

FIG. 14: provides a bar graph indicating the effect of nano calcium carbonate on bonding strength of glue sticks. The 6 formulations do not all have similar means (p=0.031). Commercial glue stick and 0% are significantly different from 1%. 0.25% is significantly different from 0.5%, 0.75% and 1%.

FIG. 15: provides a bar graph indicating the effect of nano calcium carbonate on bonding strength of glue sticks. There are no significant differences among formulations (p=0.134).

### DETAILED DESCRIPTION

Environmentally friendly whey-protein based adhesives are provided. These glues and adhesives provide good bonding strength, bond durability, water-resistance, low cost and are low- or non-toxic. Some aspects of the invention include products such as plywood and laminated beams (e.g. Glulams) that are prepared with adhesives that include whey protein. The terms “adhesive” and “glue” are used interchangeably, and are given the same meaning, throughout.

### Wood Adhesives

In one aspect, whey-based adhesives of the invention may be used to bond pieces of wood together. Non-limiting examples of bonded wood are plywood and laminated beams such as glulams. Plywood may generally be made up of two or more panels wood or a wood composite bonded together; glulams, wood pieces or strips bonded together to provide structural strength and are frequently used as load-bearing beams in construction. Numerous other articles can be prepared using wood adhesives of the invention, including furniture, toys, stairs, boats, etc.

As used herein, the term “wood adhesive” means is a substance that is capable of attaching surfaces (e.g. wood, cork, etc.) together by means of covalent and/or non-covalent interactions. By far, the largest amount of adhesives are used to manufacture building materials, such as plywood, structural flakeboards, particleboards, fiberboards, structural framing and timbers, architectural doors, windows and frames, and factory-laminated wood products. A wood adhesive solution of the invention can be used in the manufacture and installation of such building materials. Wood adhesives of the invention can also be used to assemble building materials in residential and industrial constructions, particularly in panelized floor and wall systems. Non-structural applications of adhesives of the invention include, but are not limited to, carpentry, woodworking, furniture assembly, and floor coverings. Wood adhesives of the invention can be used on various wood species.

In some aspects of the invention, a whey-based adhesive is an adhesive or glue that is prepared for and suitable for use with paper, cardboard, fiber, material, cloth, leather, or other article having a surface for which adhesion is desirable and for which the adhesive solution of the invention is suitable for bonding to itself or to another suitable surface.

A whey-based adhesive solution of the invention may have high wettability, coupled with a viscosity that will allow it to spread freely and make contact with the wood or other material surfaces. A “wood adhesive solution” of the invention is a liquid solution, emulsion, suspension mixture or other flowable liquid that can be applied to a wood or other surface as a bonding agent. When dried (also referred to herein as “cured”), a wood adhesive of the invention may bond two surfaces together, such as wood surfaces, or surfaces of other materials such as paper, cork, fiber, cloth, etc. In some embodiments of the invention, the two surfaces are made of the same material, and in other embodiments of the invention, the two surfaces may be made of different material. For example, wood-wood bonds, wood-carpet bonds, paper-paper bonds, paper-cloth bonds, etc. are possible using an adhesive solution of the invention. When dry, a whey-based adhesive of the invention may be clear or opaque, and may be tinted or un-tinted.

Aspects of the invention relate to protein-including adhesive solutions, methods of making and applying and uses of protein-including adhesive solutions, including wood adhesives, paper adhesives, and other adhesives. In some embodiments, the proteinaceous material to be used to make an adhesive of the invention can be derived from any natural animal-, plant- and/or microbe-derived protein such as milk proteins, keratin, gelatin, collagen, gluten, soy protein, casein, whey protein etc., or any combination thereof. In some embodiments, the proteinaceous material is whey protein. The whey protein may be used as a powder or in a solution, such as an aqueous solution. The whey protein may be a whey protein concentrate (WPC) or a whey protein isolate (WPI) and may be denatured. Denaturing may be achieved by methods known to those skilled in the art, such as by thermally denaturing.

Whey is a by-product of cheese making, which contains whey proteins, lactose, vitamins and minerals. Almost 10 kg of milk yields 1-2 kg of cheese and 8-9 kg of liquid whey, depending on the quality of milk. Whey proteins commonly consist of 50-53% 13-lactoglobulin, 19-20% α-lactalbumin, 6-7% bovine serum albumin and 12-13% immunoglobulin in bovine milk, which totally account for about 18% of total protein in milk. Whey proteins are often so-called “waste protein” for they are generally composed of compact globular proteins with lower molecular weight compared with soy protein or casein. For example, β-lactoglobulin that accounts for about half mass of whey protein has not only a globular structure that often results in very compact structures but also a molecular weight of only about 18300. These characteristics are undesirable for their application in adhesives.

However, whey proteins are readily soluble in water and able to form a homogenous solution. In addition, these proteins have abundant functional groups reactive to isocyanate, namely the residual amino groups of arginine, histidine, lysine and tryptophan, the free hydroxyl groups of serine, threonine and tyrosine, the amide groups of asparagines and glutamine, and thiol groups of cysteine. These characteristics contribute to the preparation of adhesives such as paper and wood adhesives of the invention that have good bond strength and durability when dried/cured.

Whey proteins can be pretreated in a number of ways prior to their incorporation into a adhesive solution of the invention. For example, a whey protein isolate (WPI) can be formed from a raw whey product. Some naturally occurring components of whey can be reduced or removed to form the WPI. A WPI may be made from either a sweet or an acid whey and may contain less than 5%, less than 4%, less than 3% less than 2% or less than 1% fat as well as less than 5%, less than 4%, less than 3%, less than 2%, or less than 1% carbohydrates.

Raw whey contains a number of components including proteins, lactose, minerals and lipids. The protein fraction can be separated from the other components by techniques known to those skilled in the art such as a stirred tank or a packed column ion exchange. These methods can be used to isolate the whey protein (primarily beta-lactoglobulin, alpha-lactalbumin, bovine serum albumin, immunoglobulin G, and proteose-peptones) from the other components. Once separated from the impurities such as carbohydrates, minerals and lipids, the protein fraction can be dried into a powder providing greater than 90%, 91%, 92%, 93%, 94%, 95%, 96%, 97%, 98%, 99%, or 99.5% protein with the remainder being moisture.

Purification techniques for whey protein may include membrane separation and ion exchange, with ion exchange typically capable of producing a whey protein of higher purity. Typical membrane separation techniques such as ultra filtration and diafiltration use semi-permeable membranes to separate components having molecular weights of less than 50 kDa. The resulting protein product, typically at a purity of less than 90%, is referred to as whey protein concentrate (WPC). Alternatively, other methods, including but not limited to ion exchange methods known to those skilled in the art can produce a protein powder having a purity of greater than 90% that is generally referred to as whey protein isolate (WPI).

Protein fractions such as WPI and WPC can be denatured prior to their use in an adhesive solution of the invention, such as a wood adhesive solution or a paper adhesive solution. Denaturing can unfold globular whey proteins and may result in the polymerization of the whey proteins, by disulfide crosslinking, within a protein molecule and across protein molecules. Denaturing can be achieved by thermally treating protein or a protein solution, such as a WPI solution. Denaturing results in an increase in viscosity of the solution and in some embodiments, the protein content is kept below about 45%, by weight, to prevent excessive gelation that can result from the denaturing process. In some embodiments of the invention, thermal denaturing can be achieved using a 10-45% by weight aqueous protein solution and heating the solution with agitation. In some embodiments of the invention, the pH of the aqueous protein solution is between 3 and 9, or 4 and 8, or 5 and 7. In some embodiments of the invention, the pH is about 7.

The heating in the denaturing step can be adjusted both in temperature and time to minimize or prevent over denaturation the solution. In some embodiments, the heating to denature a solution may include heating a WPI solution to a temperature between 40 and 80° C. for a period of between 15-55 minutes. In some embodiments of the invention, denaturing may include heating and maintaining a WPI solution at a temperature of 55-65° C. for from 15 to 55 minutes, or from 5 to 15 minutes. A crosslinking agent may be added to a heated WPI solution of the invention and the WPI/crosslinking agent solution may be maintained with heating and with at least occasional agitation. In some embodiments, the WPI/crosslinking agent solution is maintained between 55-65° C. for 5-15 minutes. In some embodiments, an adhesive solution of the invention, such as a wood adhesive, may include between 5-50% by weight of whey protein and 1-30% by weight of crosslinking agent.

Some aspects of the invention relate to whey-based wood adhesives that include whey protein, water, crosslinking agents, and plasticizers. Suitable crosslinking agents include, but are not limited to, multifunctional isocyanates, diisocyanates, polyisocyanates, pre-polymer of polyisocyanates, polyvinyl alcohol (PVA), ethylene-vinyl alcohol, polyvinyl formal, polyvinyl butyral, dialdehydes, polyvalent cations such as calcium or zinc, acetoacetates, enzymatic crosslinkers, or other homo-bifunctional, hetero-bifunctional or polyfunctional reagents capable of reacting with functional groups present in proteins. A single crosslinking agent or a combination of at least 2, 3, 4, or more different crosslinking agents can be used. In some embodiments, a polyisocyanates may be used and may exhibit higher functionality and higher crosslinking density than that obtained with diisocyanates. In some embodiments, a crosslinking agent used in a solution of the invention may be polymeric methylenebisphenyl isocyanate (also known by other names in the art, including, but not limited to P-MDI, crude MDI, PAPI, polymeric MDI, isocyanic acid, and polymethylenepolyphenylene ester). In some embodiments of the invention a crosslinking agent may be a polyvinyl alcohol (PVA). An adhesive solution of the invention may include between 1-30% by weight of crosslinking agent. In some embodiments, an adhesive solution of the invention includes between 1-20% by weight of crosslinking agent.

Plasticizers perform a variety of functions in adhesives of the invention, such as increasing the adhesion to specific surfaces, increasing the wet and dry tack of the adhesive, and increasing or decreasing the open time and speed of set time of the adhesive. Open time is the maximum time lapse between applying the adhesive and bringing the substrates together, within which a satisfactory bond can be achieved, whereas speed of set time is the time the adhesive takes to develop the adhesive bond after the adhesive is applied and the surfaces have been united. Plasticizers that can be used in an adhesive solution of the invention include, but are not limited to, polyvinyl acetate emulsion, an ethylene-vinyl acetate (EVA) emulsion, an ethylene-vinyl alcohol (EVAOH) emulsion, a styrene-butadiene (SB) emulsion, a styrene-butadiene-styrene (SB) emulsion, other latexes, or a combination thereof. In some embodiments, a wood adhesive solution of the invention includes between 5-50% by weight of a plasticizer. In some embodiments, a wood adhesive solution of the invention includes between 10-20% by weight of a plasticizer.

One or more of a number of other compounds can be incorporated into an adhesive of the invention. These optional compounds include, but are not limited to organic and/or inorganic fillers, binders, emulsifiers, pigment agents, stabilizing agents, defoamers, pH-adjusting agents, solvents, flame retardants, biocides, antimicrobial agents, or scent masking or adding agents.

Non-limiting examples of organic fillers include cellulosic material such as cellulose or other polysaccharides, etc. Non-limiting examples of inorganic fillers, include calcium carbonate, carbon, silica or a silicate, calcium sulphate; or any combination thereof. Fillers may be present in adhesives of the invention at levels between 0.1-10 weight %.

Adhesive solutions of the invention may include a biocide to help inhibit fungi, bacteria or growth of other undesirable organisms. One or more biocide agents may be included in an adhesive solution of the invention and may be helpful to reduce or eliminate unwanted growth in solutions in the short term and/or in solutions stored for longer periods. Non-limiting examples of biocides that may be used in adhesive solutions of the invention include commercially available water-based, VOC-free industrial biocides, e.g. the Proxel TN preservatives from Zeneca Specialities (Frankfurt, Germany). Additional non-limiting examples of biocides are benzoates, sorbates, and 1,2-benzisothiazolin-3-one(BIT)-based biocides such as PROXEL® brand biocides available from Aveceia Inc. Additional non-limiting examples include DOWICIL® brand biocides available from Dow Chemical, Polyphase® brand biocides from Troy Corporation, and Busan® brand biocides from Buckman Laboratories can also be used. It will be understood that additional suitable biocides can be used in some embodiments of the invention. Biocides may form less than 1%, by weight, of the adhesive solutions of the invention and in some embodiments, may be present in the range of about 0.01 to 0.5% w/v of an adhesive solution of the invention.

Defoamers that can be included in adhesive solutions of the invention, include, but are not limited to a polysiloxane solution such as BYK®-025 (BYK-Chemie GmbH, Wesel Germany). Additional suitable defoamers for use in adhesive solutions of the invention can be selected by those of skill in the art.

Pigment agents and/or scent masking or adding agents can be added to improve appearance and/or attractiveness of adhesive solutions of the invention. Numerous pigments and scent-contributing or scent-masking agents are known to those of skill in the art, and can be selected and included to achieve various color and scent effects as desired. Non-limiting examples of pigment agents that may be included in an adhesive solution of the invention, are Colanyl Red FGRX-100™ (Clariant AG, Muttenz, Switzerland), or a titanium dioxide pigment, e.g. Tipure R-960™ (DuPont, Wilmington, Del., USA). Pleasant odors, or a reduction of undesirable odors, may be obtained in an adhesive solution of the invention by using terpenes or pleasant smelling fatty acid esters, e.g. a lemon-like odor is obtained by adding limonene (Aldrich, Steinheim, Germany). One skilled in the art will understand how to alter color and/or smell using available pigments and scent-adding and/or scent-masking agents.

The pH of an adhesive solution of the invention may be adjusted using standard methods. In some embodiments, an adhesive solution of the invention may have a pH between 3-12, 4-11, 5-10, 6-9, 7-8, or may be about 7. In some embodiments, the pH of a wood adhesive solution of the invention may be at least 4, 5, 6, 7, 8, 9, 10, or up to 11.

Inclusion of whey proteins in an adhesive of the invention such as a wood or paper adhesive solution can provide a solution having a viscosity of up to 1000 mPa. The viscosity of a wood adhesive solution can provide for easier application to a surface. Adhesive solutions of the invention may have viscosities of greater than 100, greater than 200, greater than 300, greater than 400, greater than 500, greater than 600, greater than 700, greater than 800, greater than 900 mPa. This can eliminate the need for the addition of thickeners and other additives that can increase cost and can affect the performance of the final adhesive.

Adhesive solutions disclosed herein can be made using any variety of techniques know to those skilled in the art. For example, using a conventional stirring apparatus, components may be added and mixed to form a solution. In one embodiment, a crosslinking agent may first be mixed with the plasticizer, followed by subsequent addition of and mixing with denatured whey protein. Other additives, non-limiting examples of which are described herein, can then be added in any convenient order. For example, additives may equally well be added to the thermally denatured WPI solution prior mixing the denatured WPI solution to the crosslinking and plasticizer mixture or may be added after the WPI solution has been mixed with the crosslinking and/or plasticizer components. After the desired components are thoroughly mixed, the solution can be stored, packaged, or can be used immediately. The adhesive solutions of the invention can be stored in cans, bottles, jars, tubes, drums or other suitable packaging container to eliminate exposure to air and for extended storage of the solutions, a biocide and/or antimicrobial agent may be added to the solution to inhibit microbial activity.

Adhesive solutions of the invention can be applied to a surface using any number of techniques known to those skilled in the art. For example, solutions of the invention can be applied by brush, by spraying, by dipping, by rolling, or by machines such as roll-spreader, extruder, curtain-coater, and the technique employed can be determined by one skilled in the art after evaluating the type of wood or other product to be bonded. In some applications, an adhesive of the invention may be applied to a single surface to be contacted and bonded with a second surface that does not receive a separate application of the adhesive, and in other embodiments, an adhesive of the invention may be applied to all or part of each surface to be bonded to another surface. Wood surfaces (e.g. of an article such as a board or a wood conglomerate) can be treated prior to bonding by using techniques known to those skilled in the art, such as sealing, planing, sanding, etc. After application to a substrate or surface to be bonded, the bonding process may involve air drying or curing at room temperature. Alternatively, the drying or curing process may be accelerated, for example, by applying heat to the surface or can be slowed by cooling the surface or environment as desired. In some embodiments, pressure can be applied during some or all of the curing process, thus holding the surfaces that are to be bonded together for improved closeness and tightness of the resulting bond. For example, a clamp, a weight, or other means may be used to produce pressure to hold surfaces to be bonded together during drying or curing.

Bond strength of an adhesive of the invention can be determined using standard methods know in the adhesive industry and adhering to adhesive industry standards and measures. The dry bond strength of a wood adhesive solution of the invention may be between 8.5 to 14.5 MPa. In some embodiments, the dry bond strength is at least 9 MPa, 10 MPa, 10.5 MPa, 11.0 MPa, 11.5 MPa, 12 MPa, 12.5 MPa, 13 MPa, 13.5 MPa, 14 MPa, or 14.5 MPa. In some embodiments, the wet strength of a wood adhesive solution, when soaked in 57-63° C. water for three hours (WS3h) is up to 6.8 MPa. In some embodiments, a wood adhesive solution when boiled for 28 hours (WS28h) has a wet strength of at least 5.65 MPa.

### Plywood Adhesives and Plywood Articles

Some aspects of the invention relate to a plywood adhesive solution, methods of making and using the plywood adhesive solution, and plywood prepared using an adhesive of the invention. Plywood is a product made up of 2, 3, 4, or more sheets of wood or wood composite that are attached together using a wood adhesive of the invention to bond each wood sheet to an adjacent sheet. Thus, plywood is a multilayered series of wood or wood composite panels having an adhesive bond between each layer. In some embodiments, plywood made with a wood adhesive of the invention has each layer of wood positioned so that its grain runs perpendicular to that of each of its adjacent layers of wood. Plywood provides a strong, less expensive alternative to solid wood for many purposes including construction, furniture building etc. In some embodiments, an outer layer of plywood may be a veneer of a more desirable species of wood, such as maple, birch, etc. that is attached with a wood adhesive of the invention and provides a more attractive surface than the interior wood or wood composite of the plywood.

A plywood adhesive solution of the invention includes whey protein, water, and a modifier species, wherein the solution is a water-resistant plywood adhesive. The whey protein in a plywood adhesive solution of the invention may be denatured prior to inclusion in a plywood adhesive solution. Methods to denature whey protein can be as described herein for denaturing a whey protein for use to prepare a wood adhesive solution. Non-limiting examples of a suitable modifier species are a multifunctional isocyanate, a polyisocyanate, a pre-polymer of polyisocyanate, polyvinyl alcohol (PVA), an ethylene-vinyl alcohol, polyvinyl formal, polyvinyl butyral, a dialdehyde, or a combination of these modifier species. A plywood adhesive solution of the invention has a dry bond strength of at least 1.0 MPa, and a wet strength of at least 1.0 MPa when boiled and dried for 28 hours (WS28h). A plywood adhesive solutions disclosed herein can be made using any variety of techniques know to those skilled in the art, and components may be added in any order using a conventional stirring apparatus. As described elsewhere herein, other additives, including, fillers, binders, plasticizers, emulsifiers, pigment agents, scent-masking agents or scent adding agents, may be added to the solution in any order.

### Paper Glue/Adhesive

Aspects of the invention relate to solutions and methods of making and using safe paper glue (also referred to herein as a paper adhesive) with improved bonding strength and temperature-and-moisture resistance. As described elsewhere herein, a paper glue of the invention can be used to bond numerous materials, including, but not limited to, paper, cardboard, fiber, fabric, etc. Paper glue of the invention may be used to bond together any suitable for its use.

Paper glue of the invention comprises a milk protein, water, and a crosslinking agent. Milk proteins such as casein, or its fractions (e.g., α₃ casein, β casein, γ casein and κ casein), and whey protein or its fractions (e.g., α lactalbulmin and β lactalbumin), or a mixture thereof can be used as the source of the milk proteins. These proteins can be separated from milk using a variety of chemical and physical processing techniques. In some embodiments of the invention, the milk protein used is whey protein. The whey protein may be used as a powder or in a solution, such as an aqueous solution. The whey protein may be a whey protein concentrate (WPC) or a whey protein isolate (WPI). By concentrating and drying liquid whey after ultra filtration, whey protein concentrate or whey protein isolate are produced that vary in the percentage of protein they include. As described above, WPI may include greater than 90% by weight whey protein.

The whey protein use in paper glue solutions of the invention may be denatured. Denaturing may be achieved by methods known to those skilled in the art, such as by thermal denaturing. Denaturing results in the polymerization of the whey proteins, by disulfide crosslinking, within a protein molecule and across protein molecules. Although not wishing to be limited by any theory, it is believed that this disulfide crosslinking is important in producing strong, resistant protein films that help to achieve the attributes that make a favorable adhesive. Upon heating, the thiol groups become exposed, break and reform randomly. Interactions between different disulfide bonds and thiol-disulfide exchange lead to a form of a network defined as gel. The thiol groups can also crosslink with other polymers that have groups such as —OH. It is through gelation that whey protein become available to form large molecular or crosslink with other polymers, which is important for forming adhesive. Scientists generally agree that gelation is caused by interaction of alpha lactalbumin, beta-lactoglobulin and serum albumin, however, the denaturation of beta-lactoglobulin is mainly responsible for the gelation of whey protein. Beta-lactoglobulin is a single polypeptide chain of 162 amino acids and consists of anti-parallel beta-sheets formed by nine beta-strands and one a-helix. Each monomer has two disulphide bonds, at Cys66-Cys160 and Cys106-Cys119, and one free thiol group at Cys 121, which is buried within the native protein structure at pH<7.5. In some embodiments of the invention, the denaturation temperature is between 65-95° C. In some embodiments, the denaturation temperature is between 70-95° C.

Suitable crosslinking agents (also called co-binders) include, but are not limited to, polyvinyl alcohol (PVA), ethylene-vinyl alcohol, polyvinyl formal, polyvinyl butyral, polyvinyl acetate, ethylene-vinyl acetate (EVA), ethylene-vinyl alcohol (EVAOH), styrene-butadiene (SB), a styrene-butadiene-styrene (SB), other latexes, multifunctional isocyanate, a polyisocyanate, a pre-polymer of polyisocyanate polyvalent cations such as calcium or zinc, acetoacetates, enzymatic crosslinkers, or other homo-bifunctional, hetero-bifunctional or polyfunctional reagents capable of reacting with functional groups present in the milk proteins. A single crosslinking agent or a combination of at least 2, 3, 4, or more different crosslinking agents can be used. In some embodiments, the crosslinking agents are polyvinyl alcohol (PVA) and polyvinyl acetate. In some embodiments, a crosslinking agent/co-binder and the milk protein are present in the solution in a ratio of at least 1.1 to 0.1.

A number of other compounds can be incorporated into a paper glue solution of the invention. These compounds include solidifers, moisturizers, adhesive enhancers, organic and/or inorganic fillers, binders, emulsifiers, pigment agents, stabilizing agents, defoamers, pH-adjusting agents, solvents, biocides, antimicrobial agents, or scents. As a solidifier, for example, sodium stearate can be used. As a moisturizer, for example, propylene glycol, can be used. A non-limiting example of an adhesive enhancer is nano calcium carbonate. Non-limiting examples of fillers, defoamers, biocides, antimicrobial agents, pigment agents, and scents are provided elsewhere in the application and include others known to those of skill in the art.

Paper glue solutions disclosed herein can be made using any variety of techniques known to those skilled in the art. For example, using a conventional stirring apparatus, components may be added in any order. Any of the other additives described above can be subsequently added in any order relative to each other. For example, additives may equally well be added to the thermally denatured whey protein isolate solutions, prior to performing the crosslinking reaction or to the combined components. After the components are thoroughly mixed, the solution can be stored, packaged, or can be used immediately. The paper glue solutions may be stored in cans, bottles, jars, tubes, sticks, drums, or any other suitable container to eliminate exposure to air. For storage of some paper adhesive solutions of the invention, a biocide or antimicrobial agent can be included to inhibit microbial activity.

Paper glue solutions of the invention can be applied to a surface using any number of techniques known to those skilled in the art. For example, solutions may be applied by brush, by spraying, by dipping, by rolling, or by machines such as roll-spreader, extruder, curtain-coater, and the technique employed can be determined by one skilled in the art.

The dry bond strength of a paper glue solution of the invention may be at least 150 N. In some embodiments, a paper glue solution of the invention has an ash content of less than 0.25%, a protein content of at least 5%, and a total solid content of at least 20%. The pH of a paper glue solution of the invention can be between 3-10 (e.g., at least 4, at least 5, at least 6, at least 7, at least 8, at least 9). In some embodiments, the viscosity of a paper glue solution of the invention may be at least 300, 400, 500, 600, 700, 800, 900 and up to 1000 mPa at 20° C.

### Kits

Aspects of the invention also relate to kits. A kit of the invention may include a container, such as a can, jar, tube, or bottle, etc. containing an adhesive. The adhesive may be a wood adhesive, plywood adhesive, or a paper adhesive as described above. A kit of the invention may also include instructions for the application of the adhesive solution to a wood substrate, paper or other suitable substrate. A kit of the invention may include instructions for drying/curing including temperature and timing information. A kit of the invention may also include information about the solution of the adhesive solution and may specifically include information stating that the solution contains protein, such as whey protein. Clean-up and disposal instructions may also be provided. A kit of the invention may be offered for sale in stores such as hardware, department, drug stores, craft stores, and specialty stores, etc.

### Whey-Protein Based Environmentally Friendly Wood Adhesives

The invention includes whey-protein based environmentally friendly adhesives for structural and non-structural uses; in these adhesives whey protein are the main components, accounting for about 45 wt % of whey protein in solid content of adhesive; the adhesives are composed of whey protein solution, polyvinyl alcohol, plasticizing resins and crosslinking agent (in one example, polymeric methylene diphenyl diisocyanate). The dry bond strength (compression shear) of wood bondline is more than 10 MPa in average; and the wood bondline can bear 28 h boiling-dry-boiling test (boiling for 4 h then dry at 60° C. for 28 h and final boiling for another 4 h), and give a wet compression shear strength up to 5.65 MPa on average.

In one embodiment, the invention utilizes the whey protein to prepare a wood adhesive for structural and non-structural uses. These adhesives have good bond strength and water resistance with a dry bond strength of wood bondline more than 10 MPa (compression shear) in average and a wet compression shear strength up to 5.65 MPa in average by means of 28 h boiling-dry-boiling test. The adhesives of the invention are environmentally friendly because their cured resultants contain no toxic components and/or volatiles such as free phenol, formaldehyde, organic solvents and so on.

In one embodiment, based on its high reactivity with isocyanate and good solubility of whey proteins, a whey-protein based environmentally safe aqueous polymer-isocyanate (API) adhesive was developed for manufacturing glued laminated timber (Glulam) for structural and non-structural uses. The API formulations with various denatured whey proteins at different temperatures and heating time, polyvinyl acetate contents, polyvinyl alcohol contents, glyoxal contents, and blending processes were evaluated with 28 h boiling-dry-boiling test according to the industrial standard. The API adhesive contains about 60% of base resin (composed of about 30% whey protein denatured at 60° C. for 35 minutes in the presence of 5% polyvinyl alcohol), 25% plasticizing resin (polyvinyl acetate) and 13% crosslinking agent (polymeric methylene diphenyl diisocyanate). The dry bond strength of the API adhesive was 10.56 MPa that was a little more than the value (9.81 MPa) for both structural and non-structural use. The warm-water resistance tests (by means of the wet strength immediately tested after soaked in 60±3° C. water for 3 hours, WS3h) showed that the WS3h of the bondlines bonded with the developed API adhesives were up to 6.76 MPa that was higher than the required value for non-structural use (5.88 MPa, WS3h). The boiling-water resistance tests (by means of the wet strength in 28 hours boiling-dry-boiling test, WS28h) that represents the water proof or bond durability of the bondline indicated that the WS28h have been improved gradually from that almost could not bear boiling-dry-boiling test at the beginning to 5.65 MPa. The value is very close to the required value for structural use (5.88 MPa, WS28h).

### Additional Descriptions

Whey is a by-product of the cheese production, which contains whey protein, lactose, vitamin and mineral. It is estimated that almost 10 kg of milk gives 1 kg to 2 kg of cheese and 8 kg to 9 kg of liquid whey in cheese industry, depending on the quality of milk^{[1]}, or the production of 1 kg of caseinate yields 2 kg of whey solids^{[2]}. Whey proteins commonly consist of 50-53% β-lactoglobulin, 19-20% α-lactalbumin, 6-7% bovine serum albumin and 12-13% immunoglobulin in bovine milk^{[3, 4]}, which totally accounted for about 18% of protein in milk. Whey proteins are often so-called “waste protein” for they are generally composed of compact globular proteins with lower molecular weight compared with soy protein or casein^{[5}]. For example, β-lactoglobulin that accounts for about half mass of protein has not only a globular structure that often results in very compact structures but also a molecular weight of about 18300^{[4]}. These characteristics are undesirable for their application in adhesives. The patent searches in the databases of U.S. patent (USPO) and international patent (WIPO) indicated that there is no patent so far (Feb. 16, 2009) to utilize whey protein to prepare wood adhesives. Whereas, it is believed that use of whey proteins in adhesives will give them a higher added value than application in food^{[5]}.

In order to prepare high-quality wood adhesives with the globular whey protein as main components, there are two key problems shall be solved indispensably—to unfold the globular structure and to increase the molecular weight and/or intermolecular crosslinking degree. Therefore, the invention herein applies thermal denaturation to unfold the globular structure of whey protein and polymeric methylene diphenyl diisocyanate (or called p-MDI or MDI) as crosslinking agent to increase the crosslinks between unfolded whey protein molecules.

The thermal denaturation just unfolds partially, but not fully stretches, the globular structures of whey protein under gentle conditions; therefore, this denatured whey protein can not only release the polar groups that either hid within globular structures of whey protein or bonded via non-covalently (such as hydrogen bond) to fold the chains of whey protein to specific space structures, but also offer additional cohesion strength of the adhesive via keeping the inherent intermolecular disulfate linkages. Meanwhile, the gentle denaturing condition will also prevent the whey proteins from gelation during thermal denaturation and result in a good fluid or wettability of whey-protein based adhesive on wood surfaces when spreading. Without the unfolding, the globular proteins mostly formed compact layer or sometimes rigid particle via adsorption^{[6-7]} such that both cases would lead to poor interface strength or bond strength during adhesion.

The idea that introducing MDI into denatured whey protein solution was enlightened by the aqueous vinyl polymer solution-isocyanate adhesive (API) developed in the early 1970s in Japan^{[8]}. The API adhesive can bear 28 hours boiling-dry-boiling test (boiling for 4 hours then followed dry at 60° C. for 20 hours and boiling for another 4 hours)^{[9]} and can give wood bondline wet compression shear strength more than 5.88 MPa after 28 hours boiling-dry-boiling treatment. So, this API can be used to bond some wood products for structural use, such as glued laminated timber (Glulam) for structural components in constructions. However, it is very interesting that either aqueous vinyl polymer solution or MDI can not give similar bond strength and water resistance when use separately them in wood bindline with the same amounts in API formation. When we found that whey protein can be well dissolved in water and form a homogenous solution with concentration up to 40% by mass, the concept of whey-protein based aqueous polymer-isocyanate (wpAPI) adhesive was emerged due to the fact the whey proteins have some, though may be insufficient, groups that are reactive to MDI (such as residual amino groups, hydroxyl groups and mercapto groups) and therefore can be crosslinked by MDI. A non-limiting example of preparation of the wpAPI adhesive for structural wood bonding included 3 steps, as follows:

Step I: Dissolving of Whey Protein Isolate in Water with High Concentration

The basic requirement of adhesive with good bond strength is the necessary amounts of polymers that can form a continuous layer between adherends, and endure enough stress or load to prevent the bonded adherends from separation from each other when the joints are subjected to a load. Therefore the solid content of wood adhesive shall not be less than 30 wt % generally. The invention herein gives a method to obtain a whey protein isolate (WPI) solution in water with concentration up to 40% by mass, as follows:

In a container equipped stirrer and thermostat, 600 parts of water were added and heated to temperature ranged from 40-49° C., then gradually charged a total of 400 parts of WPI powder (It is better to charge more WPI powder when the previously charged WPI has dispersed in solution). The charge will last for 0.5 to 2 hour that depends on the total weight of water and WPI, for the more total weight needs the more charge time. When all WPI was charged, the mixture was kept at 45-49° C. for another 30-45 minutes. Then the mixture was cooled down and deposited at 2-25° C. for overnight before use. WPI solution was kept at 2-5° C. for longer storage.

The 40 wt % WPI solution generally had viscosity ranged 200-300 cP at 20-23° C. and pH value ranged 6.0-7.0.

In order to increase the storage of WPI solution, 0.01-0.1 wt % of formic acid or 0.01-0.5 wt % sodium formic can be added into the water before dissolving the WPI. It will prolong the storage of WPI solution from some days at room temperature to some weeks or even some months.

Sometimes, the WPI solution may form lots of foam during salvation; therefore 0.01-0.5 wt % defoamer (polysiloxane solution such as BYK®-025, BYK-Chemie GmbH, Wesel Germany) was used. It was best to introduce deformer after WPI charged but before keeping the mixture at 45-49° C. for another 30-45 minutes.

The temperature during dissolving shall not be more than 55° C., otherwise the denaturation of dissolved WPI will occur obviously that prevent the WPI from further dissolving. If the temperature is less than 35° C., the charge will spend much time and it is hard to obtain a WPI solution with concentration 40 wt %.

The pH value during salvation shall be controlled at 5.2-7.0, and is in some embodiments may be in the range of 5.5-6.8.

### Step II: Thermal Denaturation of WPI Solution in the Presence of PVA

The purposes of the thermal denaturation in this invention are to unfold partially the globular structures of whey protein meanwhile to keep the inherent intermolecular disulfate linkages. Therefore, thermal denaturation can improve bond strength of whey protein based adhesives for the polar groups were released to adsorb the polar surfaces of wood or other adherents. The basic thermal denaturing process is,

In a container equipped stirrer and thermostat, add 100 parts of WPI solution with concentration ranged 10-40 wt %, then heat it to temperature ranged from 60-63° C. with stirring, and keep for 15-55 min. After that, add 0-50 parts of polyvinyl alcohol solution with concentration ranged from 5-15 wt %, well blending and then heat to and keep at 60° C. for 5-15 min. Finally cool down.

In order to obtain a denatured WPI solution suitable for wpAPI adhesives, three parameters, namely denaturing temperature, denaturing time and WPI concentration, shall be strictly controlled for WPI contains some components that are easily gelled when temperature is more than 65° C. Therefore, the denaturing temperature shall not be more than 65° C. and be preferable to be 60-63° C. when the concentration of WPI solution is more than 15 wt %. For example, the WPI solution will be soon gelled when the system temperature is more than 65° C. if the concentration is more than 15 wt %; and a 10 wt % WPI solution can be denatured at 85° C. without gelation for 30 min or more. When thermal denaturing 40 wt % WPI solution at 60-63° C., the denaturing time shall be less than 45 min and it is preferable to keep for about 25-35 min. With denaturing time increased, the viscosity of denatured WPI is sharply increased. When it is more than 45 min, the viscosity is too large to use as adhesive for its poor fluid and wettability to wood surface.

The PVA is crosslinkable to whey protein. Therefore the 5-15 wt % PVA solution was post-added into denatured WPI. After PVA added, the WPI/PVA mixture will become very sticky if the further mixing time at 60-63° C. more than 15 min or even gelled. The PVA amount introduced is 1.5-15 wt % (solid basis over solid WPI) for the more PVA introduced will sharply reduce the solid content of final adhesive because the preferable PVA concentration is just 5-15 wt %. The solid content of WPI/PVA mixture shall be no less than 30 wt %.

### Step III: Adhesive Formulation and Wood Bonding

Formulation of the wpAPI adhesive: In a container with strong stirrer, added 60 parts of commercial polyvinyl acetate (PVAc, e.g., the Celvol® PVA 825 from HEXION) then 30 parts of commercial MDI (e.g., RUBINATE® M from HUNTSMAN), well blending to a homogeneous mixture. After that added 140-200 parts of denatured WPI/PVA mixture in Step II, and again well blending to homogeneous mixture which is the final whey-protein based API adhesive used to bond wood and wood products for structural use.

Wood bonding: The formulated wpAPI adhesive was sprayed evenly onto the neat smooth surface of solid-wood piece, timber or solid wood product with a resin consumption of 100-150 g/m². Then the resined wood surface was matched with another resin-free solid-wood piece, timber or solid wood product, and made a bondline. After then repeat previous operations to form another bondline continually if applicable. After that the bondline(s) were subjected to a static pressure ranged from 1 MPa to 1.5 MPa for at least 2 hours to 24 hours at ambient temperature (not less than 20° C.). Finally remove the static pressure and deposit the bondline(s) at ambient for 72 hours before use.

In the invention herein, the polyvinyl alcohol (PVA) is introduced into denatured whey protein in order to increase the crosslinking degree of the adhesive, by which improves the bond strength and water resistance of final wpAPI adhesives. The polyvinyl acetate emulsion was introduced in order to plasticize the protein-MDI system, to distribute MDI well within the denatured whey protein and to reduce the cost of the adhesive. No more than 20 wt % fine calcium carbonate powder can be introduced as filler, which will further reduce the cost of wpAPI adhesive.

The wood bondline prepared with above processes could bear 28 h boiling-dry-boiling test and the wet compression shear strength (WCSS₂₈ₕ) in 28 h boiling-dry-boiling test was up to 6.05 MPa and 5.65 MPa in average according to JIS K6806-2003 standard. This value is comparable the required one in JIS K6806-2003 standard (5.88 MPa) for structural use. The dry compression shear strength (DCSS) value was up to 11.55 MPa and 10.56 MPa in average, which is more than the required value in JIS K6806-2003 standard (9.81 MPa) for structural use.

Table 1 provides some test results of bond strengths of wood (Birch, Betula platyphylla Suk.) bondline with various whey protein based adhesive,*¹

TABLE 1

| | | DCSS | WCSS_{28 h} |
|---|---|---|---|
| ID | Adhesive Formations and components | (MPa) | (MPa) |
| A | 40 wt % WPI solution only without | 2.06 | 0*¹ |
| | denaturation | | |
| B | 40 wt % WPI solution denatured @ 60° C. for | 2.10 | 0.17 |
| | 35 min | | |
| C | 140 parts of 40% WPI solution without | 4.83 | 0.35 |
| | denaturation, | | |
| | 60 parts of commercial PVAc emulsion | | |
| | 30 parts of commercial MDI | | |
| D | 140 parts of 40% WPI solution denatured | 6.02 | 3.70 |
| | @ 60° C. for 35 min, | | |
| | 60 parts of commercial PVAc emulsion | | |
| | 30 parts of commercial MDI | | |
| E | 156 parts of denatured WPI/PVA mixture | 10.56 | 5.65 |
| | (130 parts of 40 wt % WPI solution | | |
| | denatured @ 60° C. for 25 min, then | | |
| | added 26 parts of 15 wt % PVA solution | | |
| | and denatured @ 60° C. for another 10 min) | | |
| | 60 parts of commercial PVAc emulsion | | |
| | 30 parts of commercial MDI | | |

Note 1: The bondlines were all delaminated during second 4-hour boiling.

### REFERENCES

[1] Datta D., Bhattacharjee C., Datta S. Whey Protein Fractionation using Membrane Filtration—A Review. Journal of the Institution of Engineers (India)-Chemical Engineering Division, 2008, 89:45-50
[2] de Wit J. N. Nutritional and Functional Characteristics of Whey Proteins in Food Products. Journal of Dairy Science, 1998, 81 (3): 597-608.
[3] Tunick M. H. 2008 Whey protein production and utilization: a brief history. In Whey processing, functionality and health benefits, edited by Onwulata C. I. and Huth P. J., pp8. Ames: Blackwell Pub.
[4] Walstra P., Geurts T. J., Noomen A., Jellema A., van Boekel M. A. J. S. 1999 Dairy Technology—principles of milk properties and processes, pp 80. New York: Marcel Dekker
[5] van der Leeden M. C., Rutten A. A. C. M., Frens G. How to develop globular proteins into adhesives. Journal of Biotechnology, 2000, 79: 211-221
[6] Haynes C. A., Norde W. Structure and stabilities of adsorbed protein. Journal of Colloid Interface Science, 1995, 169: 313-328
[7] Norde W., Favier J. P. Structure of adsorbed and desorbed proteins. Colloids surface, 1992, 64(1): 87-93
[8] Hori N., Asai K., Takemura A. Effect of the ethylene/vinyl acetate ratio of ethylene-vinyl acetate emulsion on the curing behavior of an emulsion polymer isocyanate adhesive for wood. Journal of Wood Science, 2008, 54:294-299
[9] Japan Industrial Standard JIS K6806-2003: Water based polymer-isocyanate adhesives for woods
   Some Detailed Cases when Developed the wpAPI Adhesives

### Case I: Investigate the Effect of WPI/Polyvinyl Acetate (WPI/PVAc) Ratios

### Materials:

1) Denatured 40 wt % WPI solution: the 40% WPI solution was thermally denatured at 60-63° C. for 15 minutes.

2) Commercial PVAc emulsion (Cascorez IB-S17, Hexion Specialty Chemicals)

3) Polymeric methylene diphenyl diisocyanate (MDI, supplied by University of Maine)

### Blending Process:

1) In a beaker, proper PVAc emulsion and 40 wt % WPI solution were added which resulted in the weight ratios (on the liquid bases) of WPI solution being 0% (PVAc only, control), 40%, 60%, 70% and 100% (WPI solution only), respectively; well blending to form a evenly mixture.

2) Based on the weight of each WPI/PVAc mixture, 15 wt % MDI (on the liquid bases) was added and well blending to form evenly mixture.

These mixtures are the whey-protein based aqueous polymer-isocyanate (wpAPI) adhesives for woods.

### Preparing Wood Bondline and Strength Test:

According to the industrial standard^{[9]}, the wpAPI adhesives prepared above was used to bond solid birch wood blocks. The wet compression shear strengths (WCSS₂₈ₕ) of wood bondlines were tested after 28 hours boiling-dry-boiling treatment.

### Results:

The wet compression shear strengths of wood bondline with wpAPI adhesive prepared with various WPI/PVAc ratios were presented in Table 2. For the purpose of structural use the API adhesive must have wet compression shear strength more than 5.88 MPa after 28 hours boiling-dry-boiling treatment. The results in Table indicated that these wpAPI had WCSS₂₈ₕ far less than the requirement (5.88 MPa). However, the WCSS₂₈ₕ values were increased with WPI/PVAc ratio, which indicated that WPI is better than PVAc. It is resulted from that WPI contains some groups (such as amino groups and mercapto groups) that can react with MDI such that the WPI can be crosslinked by MDI and formed stronger network that can not only bear 28 hours boiling-dry-boiling treatment but also result in higher WCSS₂₈ₕ if it contains more WPI in network. However, we found that the mixture of WPI and MDI only (without PVAc) would come to gel soon after blending and the texture of mixture is not good as others contained PVAc (there were many white micro-particles). Therefore the WPI/PVAc with a liquid weight ratio of 2.3/1 is better in general, and this ratio is used in further studies.

TABLE 2
the WCSS_{28 h} of wood bondline with various WPI/PVAc ratios

| WPI solution | WPI/PVAc | | WCSS_{28 h} |
|---|---|---|---|
| (%) | ratio | Formations | (MPa) |
| 0% | 0/1 | 100 parts PVAc emulsion, | 0.17 |
| | | 15 parts of MDI | |
| 40% | 0.67/1 | 60 parts PVAc emulsion, | 0.13 |
| | | 40 parts WPI solution, | |
| | | 15 parts of MDI | |
| 60% | 1.5/1 | 40 parts PVAc emulsion, | 0.26 |
| | | 60 parts WPI solution, | |
| | | 15 parts of MDI | |
| 70% | 2.3/1 | 30 parts PVAc emulsion, | 1.26 |
| | | 70 parts WPI solution, | |
| | | 15 parts of MDI | |
| 100% | 1/0 | 100 parts WPI solution, | 2.64 |
| | | 15 parts of MDI | |

### Case II: Investigate the Effect of WPI/PVAc/MDI Blending Process

MDI is more reactive to WPI solution than PVAc emulsion for the gel time of PVAc/MDI mixture (more than 9 hours) is much more than that of WPI/MDI mixture (about 1.5 h). So, the effects of two WPI/PVAc/MDI blending processes were investigated as follows:

Common one: blending WPI solution with PVAc emulsion before blending with MDI.

New one: blending PVAc emulsion with MDI before blending with WPI solution.

### Materials:

1) Denatured 40 wt % WPI solution: the 40% WPI solution was thermally denatured at 60-63° C. for 15 minutes.
2) Commercial PVAc emulsion (Cascorez IB-S17, Hexion Specialty Chemicals)
3) Polymeric methylene diphenyl diisocyanate (MDI, supplied by University of Maine)
4) Formation: 30 parts PVAc emulsion, 70 parts 40 wt % WPI solution denatured at 60° C. for 15 min, and 15 parts of MDI

TABLE 3
the WCSS_{28 h} of wood bondline with various blending process

| | | WCSS_{28 h} |
|---|---|---|
| Blending process | Details | (MPa) |
| Common process | (PVAc + WPI) then MDI | 1.26 |
| New process | (PVAc + MDI) then WPI | 3.42 |

### Results:

The adhesive prepared with new process (blending PVAc with MDI before blending with WPI) had much better bond strength and water resistance than that with common process, as shown in Table 3. It may be resulted from that the reactive MDI enters into the PVAc micelles that prevent it from chemical interacting with whey protein during blending; while the WPI/PVAc/MDI mixture spread onto the wood surface, the PVAc micelles broke for the water (the disperse phase) quick dispersed into porous wood such that the wrapped MDI came out and reacted with WPI (forming crosslinked network) and wood (forming chemical bonding).

Therefore, the New Blending Process will substitute for the Common one in further studies.

### Case III: Investigate the Effect of Denaturing Time

Theoretically, the more thermal denaturing time will unfold more globular structures of whey proteins meanwhile it will increase the possibility for the thermal gelation of whey protein. Therefore the effects of denaturing times of 40 wt % WPI solution at 60-63° C. on the bond strength and water resistance was investigated as follows:

Variant: denaturing time for 0, 15, 25, 35, 45 and 55 min, respectively.

### Materials:

1) Denatured 40 wt % WPI solution at 60-63° C. for 0, 15, 25, 35, 45 and 55 min, respectively.
2) Commercial PVAc emulsion (Cascorez IB-S17, Hexion Specialty Chemicals)
3) Polymeric methylene diphenyl diisocyanate (MDI, supplied by University of Maine)
4) Formation: 30 parts PVAc emulsion, 70 parts 40 wt % denatured WPI solution, and 15 parts of MDI
5) New blending process: blending PVAc emulsion with MDI before blending with WPI solution.

### Results:

TABLE 4
the WCSS_{28 h} of wood bondline with various denaturing times

| Denaturing | | | | |
|---|---|---|---|---|
| time | Viscosity*¹ | Viscosity*² | | WCSS_{28 h} |
| (min) | (cP, 20° C.) | (cP, 20° C.) | Texture*³ | (MPa) |
| 0 | 285 | 47.1 | Homogeneous, | 0.35*⁴ |
| | | | very good fluid | |
| 15 | 17252 | 84.3 | Homogeneous, | 1.03 |
| | | | good fluid | |
| 25 | 36232 | 90.4 | Homogeneous, | 3.50 |
| | | | poor fluid | |
| 35 | 412000 | 178.1 | Homogeneous, | 3.70*⁵ |
| | | | poor fluid | |
| 45 | NA | 2564 | Particle-like | 3.74 |
| | | | coagula, | |
| | | | very poor fluid | |
| 55 | NA | 6173 | Particle-like | 3.21 |
| | | | coagula, no fluid | |

Note 1: the viscosity refers to the original denatured WPI solution without dilution
Note 2: the viscosity refers to the denatured WPI solution diluted to a solid content of 25 wt %
Note 3: the viscosity and texture refer to those of denatured WPI solution
Note 4: the dry compression strength was supplemented to be 4.83 MPa with this formula
Note 5: the dry compression strength was supplemented to be 6.02 MPa with this formula

The results in Table 4 indicated that the denaturing time affected not only the texture of whey protein but also the bond strength. With denaturing time increased, the viscosity of denatured WPI solution sharply increased from 285 cP to that more than 10⁶ cP, which indicated that the WPI denatured at 60° C. for longer time will result in more and more gelation. When WPI was denatured for more than 45 min, many particle-like coagula would form and the solution becomes almost gel (no fluid). The bond strengths after 28 hours boiling-dry-boiling treatment were increased gradually from 0.35 MPa to 3.74 MPa with denaturing time increased to 45 min, and then slightly reduced with further increase of denaturing time.

Therefore, the denaturation of 40 wt % WPI solution at 60-63° C. for 35 min will be applied in further studies.

Case IV: Investigate the Effect of WPI Denatured with PVA

Due to the fact that the molecules of whey proteins have no too many reactive groups (mainly the amino groups, hydroxyl groups and mercapto groups) to isocyanate, the denatured WPI could not form a network with sufficient crosslinking points. Therefore, the polyvinyl alcohol (PVA) with larger molecular weight (about 65000) was introduced to WPI solution with following considerations: a) PVA has abundant hydroxyl groups that can interact will WPI so that part WPI will be crosslinked by PVA; b) the OH groups in PVA is also reactive to isocyanate, by which the WPI may be chemical linked to PVA by MDI and therefore increase the crosslinking points; and 3) PVA itself is a good wood adhesive for its abundant polar OH groups. Current work is to determine the amount of PVA introduced.

### Variant (PVA Amount Introduced):

WPI/PVA=11.7, 5.0, 2.8 and 1.6 (ratio of solid basis), respectively.

Denaturation of WPI with PVA:

In a container equipped stirrer and thermostat, add 100 parts of 15 wt % PVA solution and 25-250 parts of water and then heat to 40-49° C., then gradually charge total 41.7-175 part of WPI powder. When all WPI charged, keep the mixture at 45-49° C. for another 30-45 minutes. After that heat to 60-63° and keep for 25 min or 35 min, then cool down.

### Materials:

1) PVA (Celvol PVA 825)
2) Denatured WPI in the presence of various PVA
2) Commercial PVAc emulsion (Cascorez IB-S17, Hexion Specialty Chemicals)
3) Polymeric methylene diphenyl diisocyanate (MDI, supplied by University of Maine)
4) Formation: 30 parts PVAc emulsion, 70 parts 40 wt % denatured WPI solution contained PVA, and 15 parts of MDI
5) New blending process: blending PVAc emulsion with MDI before blending with WPI solution containing PVA.

### Results:

TABLE 5
the WCSS₂₈ₕ of wood bondline in the presence of various PVA

| PVA/ | PVA*¹ | WPI*¹ | Denaturing | Viscos- | | |
|---|---|---|---|---|---|---|
| WPI | content | content | time | ity*² (cP, | | WCSS₂₈ₕ |
| ratio | (%) | (%) | (min) | 20° C.) | Texture*² | (MPa) |
| 1/11.7 | 3 | 35 | 25 | 2879 | Homoge- | 3.88 |
| | | | | | neous,very | |
| | | | | | good fluid | |
| 1/11.7 | 3 | 35 | 35 | 5289 | Homoge- | 4.21 |
| | | | | | neous, very | |
| | | | | | good fluid, | |
| | | | | | but bad | |
| | | | | | compatibility | |
| | | | | | and poor | |
| | | | | | 2 days later | |
| 1/5.0 | 6 | 30 | 25 | 14997 | Particle-like | 2.70 |
| | | | | | coagula, fluid | |
| 1/5.0 | 6 | 30 | 35 | N/A | Almost gelled | 2.50 |
| 1/2.8 | 9 | 25 | 25 | N/A | Gelled | N/A |
| 1/2.8 | 9 | 25 | 35 | N/A | Gelled | N/A |

Note 1:
the PVA content and WPI content refer to their solid content in final denatured mixtures.
Note 2:
the viscosity is tested by diluting the PVA/WPI mixture to a solid content of 25 wt %

The results in Table 5 indicated that the viscosities of the PVA/WPI mixture denatured for either 25 min or 35 min sharply increased or even gelled with PVA content increased and the mixture denatured for 35 min had larger viscosity than that for 25 min. Compared with those without PVA, the viscosity of denatured PVA/WPI mixture was much larger, confirmed the there is some strong interaction between PVA and WPI during thermal denaturation. The huge viscosity or the almost gelled mixture led to very poor fluid or wettability of the adhesive on wood surface and therefore result in poor bond strength of adhesive. The results in Table 5 also indicated that the PVA/WPI mixture with 3 wt % PVA and denatured for 35 min had best bond strength and water resistance.

### Case V: Investigate the Effect of PVA Adding Process

In Case IV, the results confirmed that the PVA had some strong interaction with WPI and can improve the bond strength of adhesive. However, with PVA amount increased, the viscosity will sharply increase and then reduce bond strength. The current study is to introduce more PVOH into WPI in order to further improve bond strength by post-adding PVA into WPI.

### Variant (PVA Adding Process):

Process I, Denaturing WPUPVA mixture at 60° C. for 25 or 35 min (the same with that in Step VI).
Process II, Denaturing 40% WPI solution at 60° C. for first period (25 or 35 min) and then added PVA solution and denatured for another 10 mins.
Process III, Denaturing 40% WPI solution at 60° C. for a period (25 or 35 or 45 min) and then added PVA solution and well blending, finally cooled down.
Note: in above processes the material concentrations in WPI/PVA mixtures were controlled the same, namely 3 wt % PVA, 35 wt % WPI and 62 wt % water.

### Results:

TABLE 6
the WCSS_{28 h} of wood bondline with various PVA adding processes

| | Denaturing | | | |
|---|---|---|---|---|
| Adding | time | Viscosity*¹ | | WCSS_{28 h} |
| process | (min) | (cP, 20° C.) | Texture*² | (MPa) |
| Process III | 25 | 889.3 | Homogeneous, | 2.78 |
| | | | very good fluid | |
| Process II | 25 + 10 | 1220 | Homogeneous, | 4.62 |
| | | | very good fluid | |
| Process I | 25 | 2879 | Homogeneous, | 3.88 |
| | | | very good fluid | |
| Process III | 35 | 1100 | very good fluid, | 4.29 |
| | | | a few coagula | |
| Process II | 35 + 10 | 1150 | Particle-like | 4.26 |
| | | | coagula, fluid | |
| Process I | 35 | 5289 | Homogeneous, | 4.21 |
| | | | very good fluid, but | |
| | | | bad compatibility | |
| | | | and poor 2 days | |
| | | | later | |
| Process III | 45 | 1130 | Many particle-like | 4.02 |
| | | | coagula, fluid | |

Note:
the viscosity is tested by diluting the PVA/WPI mixture to a solid content of 25 wt %

Test results indicated that reducing the interacting time of WPI with PVA by post-adding PVA would well improve the fluid (in terms of viscosity) and texture of final denatured WPI/PVA mixture. These will do well to the wettability of adhesive onto the adherent and therefore improve the bond strength. Therefore, the viscosities of the denatured PVA/WPI mixtures prepared with process I, II and III, respectively, were decreased generally. Results are shown in Table 6. For example of total denaturing time 35 min, the viscosity of mixture with Process I (5289 cP) was more than that with Process II (1220 cP) that in turn larger than that with Process III (1100 cP). The adhesive prepared with PVA/WPI mixture that denatured for 25+10 minutes according to Process II resulted in the best bond strength (4.62 MPa).

### Case VI: Investigate the Effect of PVA Content

Based on above results, especially from those in Case IV and Case V, we evaluated the effect the PVA contents in denatured WPI by post-adding PVA solution on the properties of adhesives, as flows:

1) Denatured 100 parts of 40 wt % WPI at 60-63° C. for 25 min;

2) Charged 0, 10, 20, 30 or 40 parts of 15 wt % PVA solution, respectively; [PVA/WPI solid weight ratio: 0, 1/26.7, 1/13.3, 1/8.9 and 1/6.7, respectively; or in terms of PVA content (the weight percentage based on solid WPI): 0%, 3.75%, 7.50%, 11.25% and 15.00%]

3) Heated to 60° C. and kept at 60-63° C. for another 10 min;

4) Cool down.

5) Took 60 parts of PVAc and blended well with 40 parts of MDI, then add 140-200 parts of above PVA/WPI denatured resultants, resulting in a series of wpAPI adhesives.

The test results were shown in Table 7, which indicated that the PVA/WPI mixtures prepared with PVA post-adding process (Process II) had good viscosity and texture. The WCSS₂₈ₕ that represents the bond strength and water resistance of bondline were increased at first then decreased. The best WCSS₂₈ₕ (5.65 MPa) was resulted from the adhesive prepared with WPI/PVA mixture contained 7.5 wt % PVA. This WCSS₂₈ₕ value was much close to the requirement of the severest industrial standard (JIS K6806-2003) for structural use (5.88 MPa). When PVA further increased, the WCSS₂₈ₕ decreased a little that must be resulted by the dilution of PVA solution that was just 15 wt % concentration.

The dry compression shear strengths of these adhesives assumed the same tendency with the wet strength when the PVA content increased. There only two formulations of wpAPI adhesive (PVA content 3.75% and 7.50%) having dry strength 9.81 MPa that is the requirement of the severest industrial standard (JIS K6806-2003) for structural use. Though the wpAPI adhesive prepared with 3.75% PVA content had highest dry strength (10.96 MPa), its wet strength (WCSS₂₈ₕ) was just 4.65 MPa.

TABLE 7
the properties of wpAPI adhesives with various PVA contents (Process II)

| | PVA*¹ | | | | |
|---|---|---|---|---|---|
| PVA/WPI | content | Viscosity*² | | WCSS_{28 h} | DCSS*³ |
| solid ratio | (wt %) | (cP, 20° C.) | Texture*² | (MPa) | (MPa) |
| 0 | 0 | 178.1 | Homogeneous, | 3.70 | 6.02 |
| | | | good fluid | | |
| 1/26.7 | 3.75 | 2238 | Homogeneous, | 3.92 | 10.66 |
| | | | good fluid | | |
| 1/13.3 | 7.50 | 2471 | Homogeneous, | 5.65 | 10.56 |
| | | | good fluid | | |
| 1/8.9 | 11.25 | 3075 | Homogeneous, | 4.65 | 9.26 |
| | | | good fluid | | |
| 1/6.7 | 15.00 | 3253 | Homogeneous, | 4.65 | 7.42 |
| | | | good fluid | | |

Note 1: the PVA content refer to the weight percentage of solid PVA on basis of solid WPI.
Note 2: the viscosity is tested by diluting the PVA/WPI mixture to a solid content of 25 wt %
Note 3: the DCSS refers to the dry compression shear strength.

Therefore the best whey-based API adhesive was prepared with the WPUPVA mixture that the 15 wt % PVA solution was post-added and contained 7.5 wt % PVA on the solid basis of solid WPI; this adhesive can be used as structural wood adhesive. Its formation and preparation are as follows:
1) 130 parts of 40 wt % WPI solution denatured at 60-63° C. for 25 min with stirring;
2) Charged 26 parts of 15 wt % PVA solution into the resultant in step 1);
3) Heated the mixture in step 2) to 60° C. and kept at 60-63° C. for 10 min with stirring;
4) Cooled down. Kept the resultant at 2-10° C. for storage;
5) Took 60 parts of PVAc emulsion (solid content 55%) and blended well with 30 parts of MDI (100% solid content);
6) Blended well the resultant in step 5) with 156 parts of the resultant in step 4). It is the whey protein based API adhesive.

It should be understood that not all of the above-identified advantages may be achieved in all embodiments of the present invention. The present invention will be further illustrated by the following examples, which are intended to be illustrative in nature and are not to be considered as limiting the scope of the invention.

### EXAMPLES

### Example 1

### Novel Whey-Protein Based Aqueous Polymer-Isocyanate (API) Adhesives for Glulam (Glued-Laminated Timber)

A novel API adhesive for Glulam was developed using whey protein a byproduct of cheese making. The whey-protein based API adhesives were characterized by bond test, Fourier Transform Infrared (FTIR) spectroscopy and Scanning Electron Microscope (SEM) for bond strength and durability, chemical structures and morphology. The optimized whey-protein based API adhesive had a 28 h boiling-dry-boiling wet strength 6.81 MPa and a dry strength 14.34 MPa according to the test procedures in JIS K6806-2003 standard. The addition of PVAc emulsion can prolong the work life of the novel API adhesive. Addition of crosslinker MDI can not only increase the cohesive strength of the cured adhesive by crosslinking whey protein and PVA, but contribute the strong chemical bonds via urethane linkage in wood bondline. Addition of PVA further increased the crosslinking density of the cured adhesive by crosslinking to whey protein and reacting with MDI. The use of nano-CaCO₃ also significantly improves bond strength and durability due to its mechanical interlocks with the polymers in the adhesive. In addition, both PVA and nano-CaCO₃ improved the compatibilities of the components in the optimized API adhesive. Results show that MDI reacts mainly with the residual amino groups rather than the hydroxyl groups of whey proteins.

Glulam (glued-laminated timber) is a structural wood composite manufactured by gluing individual smaller pieces of wood together using adhesives. Due to the advantages of large section sizes, long lengths, excellent dimensional stability and good strength, Glulam is used in a wide variety of applications in Europe, North America, and Japan, ranging from headers or supporting beams in residential framing to major structural elements in non-residential buildings including recreational buildings, industrial structures requiring large column free spaces, and high quality architectural/structural uses in churches, shopping centers and so on[1]. The common adhesives for the Glulam are resorcinol-formaldehyde (RF) resin, phenol-resorcinol-formaldehyde (PRF) resin and aqueous polymer-isocyanate (API) adhesive (the mixture of crosslinker MDI with water base glues prepared with poly vinyl alcohol solution and the mixtures of PVA with PVAc emulsion, styrene-co-butadiene rubber emulsion, ethylene-co-vinyl acetate emulsion, or their mixtures), and melamine-urea-formaldehyde based honeymoon adhesive[2-4]. With the increased interest in the use of more biomass materials for substituting fossil resources, some biomass based adhesives were developed for Glulam, such as tannin-resorcinol-formaldehyde adhesive[5] and tannin-resorcinol-formaldehyde honeymoon adhesive[6]. In current study, we are aiming at developing a novel API adhesive using whey protein for structural-used Glulam.

Whey is a by-product of cheese making, which contains whey proteins, lactose, vitamins and minerals. About 9 L of whey is generated for every kilogram of cheese manufactured and about 90.5 billion pounds of whey was estimated to be generated in USA in 2008 according to the Annual Summary of Dairy Products, USDA National Agricultural Statistics Service. However, more than 30% of the whey is disposed to the environment in recent year in the US, thus, there is an increasing economical and environmental need for finding new applications for whey proteins. Whey proteins commonly consist of 50-53% 13-lactoglobulin, 19-20% α-lactalbumin, 6-7% bovine serum albumin and 12-13% immunoglobulin in bovine milk[7], which totally account for about 18% of total protein in milk. Whey proteins are often so-called “waste protein” for they are generally composed of compact globular proteins with lower molecular weight[8]; these characteristics are undesired for the applications of whey protein in adhesives.

However, whey protein is readily soluble in water and able to form a homogenous “solution” with concentration up to 40% by weight; in addition, whey proteins are rich in free hydroxyl groups (totally up to 17.2 g amino acids in 100 g whey protein) and residual amino groups (totally up to 13.4 g amino acids in 100 g whey protein)[9]. With these two characteristics, the whey-protein solution can be used to prepare aqueous polymer-isocyanate (API) adhesive for structural wood.

### Materials and Treatments

NZMP whey protein isolate (WPI) was purchased from Fonterra Ltd. (New Zealand) with protein content 92.4%; dissolve in water to form 40 wt % solution before use. Polyvinyl alcohol (PVA) was purchased from Celanese Ltd. (Texas, USA) with degree of hydrolysis 98.0-98.8% and molecular weight about 65000; dissolve in water to form 15 wt % solution before use. Polymeric MDI was purchased from HUNTSMAN Polyurethane (Texas, USA) with NCO weight content 31.4%. Polyvinyl acetate (PVAc) was purchased from HEXION Specialty Chemicals (Ohio, USA) with solid content 55%. Nano-calcium carbonate, HG-01, was purchased from Shanghai Huijing Sub-nanoseale New Materials Co. Ltd (Shanghai, China) with particle size less than 40 nm. Styrene butadiene rubber (SBR) emulsion was purchased from BASF Chemical Company (Ludwigshafen, Germany) with solid content 53.6%. Unless stated otherwise, the materials were used as received without further treatments.

### Preparation of Whey-Protein Based API Adhesives

There are total of 6 API adhesives investigated in current studies. The weight ratio of crosslinker MDI to water-base glue (as shown in Table 8) was 3/20 on liquid basis. In the API adhesive from A to B, the 40 wt % WPI solution was thermally denatured at 60-63° C. for 35 min. In the API adhesives C to D, the WPI solution was thermally denatured at 60-63° C. for 25 min then charge 20 wt % of PVA solution (based on WPI solution) and then kept at 60-63° C. for another 10 min. In the API adhesive D, the fine CaCO₃ powder was charged into the denatured WPI/PVA mixture that just cooled down to about 25° C. The adhesive E is one of commercial API ones that was used as a control.

TABLE 8
The dry and wet strength of whey-protein based adhesives prepared with
various process

| Adhesive | Composition of | Strength (MPa) | |
|---|---|---|---|
| ID | the water base glue (wt %, liquid basis) | DCSS | WCSS_{28 h} |
| Control* | WPI (100%) | 2.06 | ≈0 |
| A | WPI (100%) | 5.78 | 2.64 |
| B | WPI (70%) + PVAc (30%) | 6.02 | 3.70 |
| C | WPI (58.3%) + PVA (11.7%) + | 10.56 | 5.65 |
| | PVAc (30%) | | |
| D | WPI (55.4%) + PVA (11.1%) + | 13.38 | 6.81 |
| | CaCO₃ (3.5%) + | | |
| E | PVAc (54%) + PVA (24%) + | 12.98 | 6.37 |
| | SBR (11%) + CaCO₃ | | |

Note:
The Control was just the 40 wt % of denatured WPI solution (at 60° C. for 35 min) without MDI.

### Wood Bonding Performance

Wood bonding performance of the adhesive was evaluated by the 28 h boiling-dry-boiling wet compression shear strengths (WCSS28h) and dry compression shear bond strength (DCSS) at breakage according to JIS K6806-2003 Standard: Water based polymer-isocyanate adhesives for woods. The wood adherent pieces were birch (Betula platyphylla Suk.) with dimensional size 30 mm length (fibre direction)×25 mm width×10 mm thickness. The bonded blocks were pressed at 1.5 kN for 2 h in Instron-5566 mechanical machine (Instron Corporation, Massachusetts, USA).

The WCSS28h reflects not only the bond strength but also the bond durability of the bondline because it undergoes two 4 h boiling treatments and a 20 h dry treatment at 60° C., while the dry compression shear strength reflects only the bond strength.

### FTIR Analysis

The samples selected for FTIR analyses should undergo freeze dry at −58° C. and 15 kPa for a week. Before freeze dry, each mixture of WPI/MDI, PVA/MDI or WPI/PVA/MDI was cured at ambient for 7 d after the water base glue mixed with MDI. The dried sample was mixed with KBr crystal at a weight ratio of 1/150 then ground well, after that pressed in a special mold to form a FTIR sample folium, and finally scanned using a Magna IR560 FTIR instrument (Nicolet Co., USA).

### SEM Observation

The SEM was employed to observe the bulk morphologies of the cured adhesive. The SEM samples were prepared as follows. Put enough fresh liquid adhesive into the 2 mm gap between two wood blocks and bonded them together, then kept at ambient temperature (20-25° C.) for 7 d. After then broke the bondline and took a piece from fractured surface of cured adhesive for SEM observation. The SEM samples were coated with approximately 10-20 nm of gold before examination with a QUANTA-200 SEM (FEI Co., USA).

### Results and Discussion

API adhesive is a two-component system composed of water-based glue and crosslinker isocyanate. Typically, the water-based glue of commercial API adhesive is poly vinyl alcohol (PVA) solution and the mixtures of PVA with PVAc emulsion, styrene-co-butadiene rubber (SBR) emulsion, ethylene-co-vinyl acetate (EVA) emulsion, or their mixtures[10]. The crosslinker isocyanate is commonly a crude form of polymeric methylene diphenyl diisocyanate (p-MDI or MDI). Due to the relative lower cost compared with other structural adhesives and environmental safety, API adhesive is widely used to bond wood for both structural and non-structural applications. To prepare a novel API adhesive for structural use, it shall be prepared the water base glue with whey protein firstly.

Whey proteins are generally composed of water-soluble linear polypeptides so that it can be dissolved in water to form a homogeneous solution with a concentration more than 40 wt %. Due to the lower averaged molecular weight compared with other proteins such as soy-bean protein and casein[6] and its good water solubility, the whey protein had very poor cohesive strength and water resistance. As a result, when used whey protein solution only as wood adhesive to bond wood, it only yielded a dry strength of 2.06 MPa that was far away from the required value (9.81 MPa) for structural use according to the JIS K6806-2003 Standard; and the wood bondline could not bear 28 h boiling-dry cycle and yielded almost no wet strength that indicated very poor bond durability, as shown in Table 8. The dry bond strength of whey protein solution only mainly came from the bond mechanism involving both the adsorption of polar groups (amino, hydroxyl, amide, carboxyl, etc.) of whey protein on wood surface and the mechanical interlocking between solid protein (binder) and porous wood (substrate).

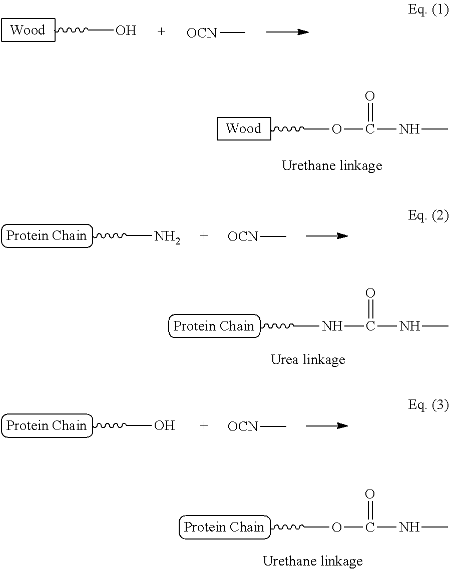

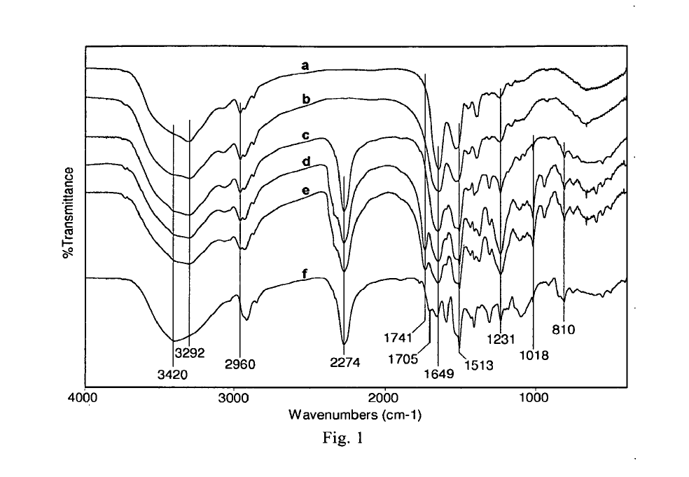

As mentioned previously, whey proteins are rich in free hydroxyl groups and residual amino groups. When 15 wt % of MDI (liquid basis) was added into WPI solution as crosslinker in Adhesive A that was the prototype of the novel whey-protein based API adhesive, the crosslinker would quickly react with the active groups in whey protein due to the highly reactivity of isocyano groups of MDI. The crosslinking reaction resulted in the increase of molecular weight of whey protein, by which improved the cohesive strength of final API adhesive. The FTIR as shown in FIG. 1 revealed that the all cured API adhesives at ambient temperature for 7 d after mixing water base glue with MDI still remained considerable free isocyano groups (NCO, which indicated that considerable free NCO could react with active groups on wood surface and formed powerful chemical (or covalent) bonding via urethane bridge between the adhesive and wood, as illustrated as Eq. (1). All these endowed the Adhesive A with much better bond strength (5.78 MPa) and bond durability than the control (A0), as presented in Table 8. The wood bondline of this API adhesive could not only bear 28 h boiling-dry cycle but also yielded a wet strength of 2.64 MPa. The FTIR spectra of cured adhesive didn't detected the C═O stretching mode of urethane at about 1705 cm-1 but detected the strong absorption at about 1649 cm-1 that assigned to the C═O stretching mode of both urea and protein; while in the cured mixture of polyvinyl alcohol solution with MDI, the IR spectrum detected not only a strong peak at about 1649 cm-1 but also a middle-strong peak at about 1705 cm-1. This observation indicated that the crosslinking reaction of whey protein by MDI was mainly carried out via the reaction of NCO with residual amino, as illustrated as Eq. (2), not via NCO/OH reaction as illustrated as Eq. (3). It was attributed to the much higher reactivity of NCO/amino reaction than that of NCO/hydroxyl one though the content of residual amino in whey protein is comparable with hydroxyl content[9]. Because the IR absorption of C═O stretching of urea linkages ranged from 1670-1630 cm-1 that was overlapped with that of protein (1649 cm-1) [11], the IR spectra could not distinguish the C═O stretching of urea from that of protein.

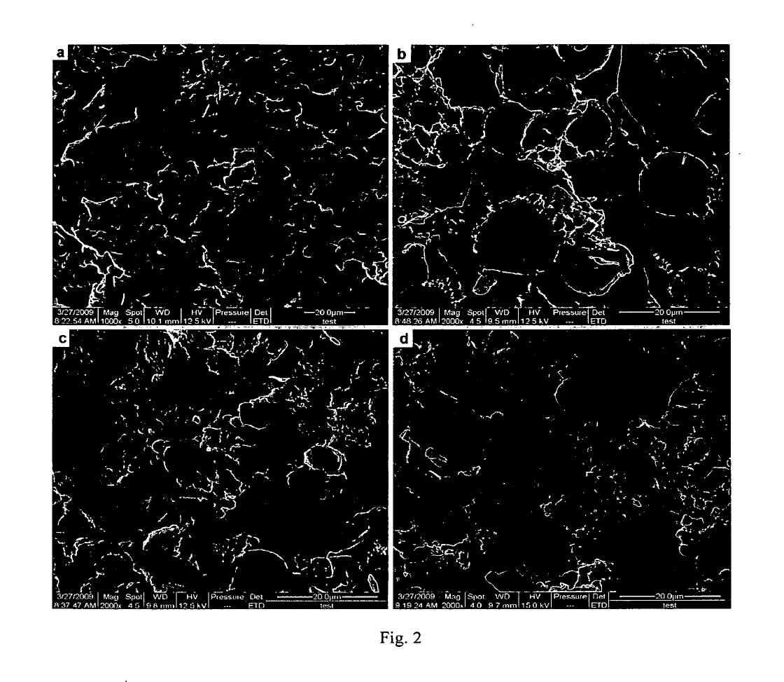

However, the work life of Adhesive A was very short, about 30 min, because the whey proteins have abundant and active residual amino groups that were quickly reacted with MDI, as illustrated by Eq. (1). Soon after the blending of WPI solution and MDI, the adhesive became very viscous and formed many particle-like accumulates due to the formation of insoluble polyurea chains, as shown in the SEM photo FIG. 2a. In order to improve the work life, we introduced 30 wt % of PVAc emulsion (liquid basis) into WPI solution to reduce the reacting rate via diluting. The test results indicated that after introducing 30 wt % of PVAc emulsion the whey-protein based API adhesive B had much longer work life (2.3 h) and 40% more wet strength than those of adhesive A. However, their dry bond strengths were comparable (6.02 MPa vs. 5.78 MPa). The addition of 30% PVAc that was inert to MDI did reduced the reaction rate of MDI with amino in protein and water via diluting them so that more free NCO could be remained for chemical bonding reaction, as illustrated as Eq. (1), and consequently improved the wet strength to some extent.

Polyvinyl alcohol (PVA) is composed of the repeating —CH2-CH(OH)— units that are rich in hydroxyl groups that can react with MDI; It has been reported that the PVA is crosslinkable to whey protein[12-13]. We introduced PVA into whey protein solution and obtained new water glue for Adhesive C with expectation to improve the bond strength and durability via increasing the crosslinking density of API adhesive. The bond tests in Table 8 showed that both dry strength (10.56 MPa) and wet strength (5.65 MPa) of Adhesive C were increased, 75.4% and 52.7%, respectively, more than those of Adhesive B without PVA addition. This confirmed that the PVA could increase the crosslinking density of final cured adhesive via the crosslinking of PVA with both WPI and MDI, and consequently improved the bond strength and durability. According to the commercial standard for structural use, the dry strength of Adhesive A4 was beyond the required value (9.81 MPa), while the wet strength was still a little lower than the required value (5.88 MPa). Though the FTIR spectrum of the WPI/PVA mixture was quite similar with that of WPI only, some differences were observed in the SEM photos of adhesive A and B. Because the PVAc chains are hydrophobic while WPI are hydrophilic, the PVAc could not be compatible well with WPI. As a result some PVAc phases were separated from the WPI phases in the cured adhesive B as indicated as the arrows in FIG. 2b. Polyvinyl alcohol contained both hydrophilic hydroxyl and hydrophobic methylene chain (—CH2-CH—), which can be acted as an emulsifier that increased the compatibility of PVAc and WPI. Therefore, the PVAc phases were all tightly bonded to the WPI phase without separation and the size of PVAc phase became smaller as shown in FIG. 2C, which increased both dry strength and wet strength of Adhesive C.

Mechanical properties of adhesives may be significantly improved with the addition of nano-scale filler[14-15] because of the large surface area of the nano-scale filler and the ability of the filler to mechanically interlock with the polymer[16]. In our study, 3.5 wt % of nano-scale CaCO₃ powder was introduced, with violent mechanical stirring (1200-1500 rpm), into the water glue in Adhesive D. The addition of nano-scale CaCO₃ powder resulted in the further increases of bond strength and bond durability. The final API adhesive had a 28 h boiling-dry-boiling wet strength (6.81 MPa) that was more than the required value (5.88 MPa) in JIS K6806-2003 standard and 20.5% more than that without nano-CaCO₃ filler (5.65 MPa); the dry strength (13.38 MPa) was also much more than the required value (9.81 MPa) in JIS K6806-2003 standard and 26.7% more than that without nano-CaCO₃ filler (10.56 MPa). The strong mechanical interlocking of nano-CaCO3 with the polymers improved the compatibilities of each component in adhesive and increase the cohesive forces of the cured API adhesive. It could be confirmed by the SEM photo in FIG. 2d that the PVAc phases and WPI phases become indiscernible, and the cured adhesive showed morphology of brittle fracturing when broke down.

Adhesive E was a commercial API adhesive for structural use. Its water glue is composed of 54 wt % of PVAc emulsion, 1.1 wt % of SBR emulsion, 24 wt % of PVA solution and 11 wt % of nano-CaCO₃ (liquid basis). The test results showed that the commercial API adhesive had dry bond strength of 12.98 MPa and wet bond strength 6.37 MPa. This result indicated that the whey-protein based API adhesive D had comparable bond strength and durability with the commercial API adhesive and therefore showed potential for commercial applications for the structural wood bonds.

### Conclusions

A novel API adhesive for Glulam was developed using whey protein, which had a 28 h boiling-dry-boiling wet strength 6.81 MPa and a dry strength 14.34 MPa according to the JIS K6806-2003 standard. The bond strength and durability of the developed API adhesive was comparable to the commercial API adhesive for structural use and can be used to prepare Glulam. The prototype API adhesive (mixing whey protein solution only with crosslinker MDI) had very short work life and poor bond strength and durability. The excellent bond strength and durability of optimized whey-protein based API adhesives should be attributed greatly to the strong chemical bonds of MDI to wood via urethane linkage and the additions of PVA and nano-CaCO₃ powder. The PVA would increase the crosslinking density of whey protein and the compatibilities between the hydrophobic PVAc phase and hydrophilic whey protein phase in the adhesive. The nano-CaCO₃ could mechanically interlock the polymers in the adhesive and further improve the compatibilities between PVAc phase and hydrophilic whey protein phase. MDI mainly reacted with the residual amino groups rather than the hydroxyl groups of the protein.

### REFERENCES

[1] Lam F. Modern structural wood products. Progress in Structural Engineering and Materials, 2001, 3: 238-245
[2] Caster R W, Gillem M M, Howel J T. Gap-filling phenolresorcinol adhesives for laminating. Forest Prod J, 1973, 23: 55-59
[3] Hori N., Asai K., Takemura A. Effect of the ethylene/vinyl acetate ratio of ethylene-vinyl acetate emulsion on the curing behavior of an emulsion polymer isocyanate adhesive for wood. Journal of Wood Science, 2008, 54: 294-299
[4] Properzi M, Pizzi A, Uzielli L. Honeymoon MUF adhesives for exterior grade Glulam. Holz Roh-Werkst, 2001, 59: 413-421
[5] Scopelitis E, Pizzi L. The chemistry and development of branched PRF wood adhesives of low resorcinol content. Journal of Applied Polymer Science, 1993, 47: 351-360
[6] von Leyser E, Pizzi A. The formulation and commercialization of Glulam pine tannin adhesives in Chile. Holz Roh-Werkst, 1990, 48: 25-29
[7] Tunick M. H. Whey protein production and utilization: a brief history. In Onwulata C. I. and Huth P. J. (Eds). Whey processing, functionality and health benefits. Blackwell, Ames, Iowa, USA, 2008, pp. 8-9
[8] van der Leeden M. C., Rutten A. A. C. M., Frens G. How to develop globular proteins into adhesives. Journal of Biotechnology, 2000, 79(3): 211-221
[9] McDonough F., Hargrove R., Mattingly W., Posati L., Alford J. Composition and properties of whey protein concentrates from ultrafiltration. Journal of Dairy Science, 1974, 57(12): 1438-1443
[10] Hori N., Asai K., Takemura A. Effect of the ethylene/vinyl acetate ratio of ethylene-vinyl acetate emulsion on the curing behavior of an emulsion polymer isocyanate adhesive for wood. Journal of Wood Science, 2008, 54: 294-299
[11] Litvinov V. M., De P. P. Spectroscopy of Rubber and Rubbery Materials. Shrewsbury, Shropshire, UK: Rapra Technology Limited, 2002, p. 100
[12] Lacroix M., Le T. C., Ouattara B., Yu H., Letendre M., Sabato S. F., Mateescu M. A., Patterson G. Use of gama-irradiation to produce films from whey, casein and soy proteins: structure and functional characteristics. Radiation Physics and Chemistry, 2002, 63(3-6): 827-832
[13] Srinivasa P. C., Ramesh M. N., Kumar K. R., Tharanathan R. N. Properties and sorption studies of chitosan-polyvinyl alcohol blend films. Carbohydrate Polymers, 2003, 53(4): 431-438
[14] Chen H., Sun Z., Xue L. Properties of nano SiO2 modified PVF adhesive. Journal of Wuhan University of Technology—Materials Science Edition, 2004, 19(4): 73-75
[15] Gilbert E. N., Hayes B. S., Seferis J. C. Nano-alumina modified epoxy based film adhesives. Polymer Engineering and Science, 2003, 43(5): 1096-1104
[16] Hussain M., Nakahira A., Niihara K. Mechanical property improvement of carbon fiber reinforced epoxy composites by Al2O3 filler dispersion. Materials Letters, 1996, 26(3): 185-191

### Example 2

### Whey-Protein Based Environmentally Friendly Wood Adhesives

Purpose—To develop an environmentally safe aqueous polymer-isocyanate (API) wood adhesive for structural uses with whey protein isolate (WPI) that is a by-product of cheese making.
Design/methodology/approach—The API formulations with whey proteins denatured at different heating temperatures and times, WPI/PVA (polyvinyl alcohol) denaturing processes, PVA contents and nano-CaCO₃ (as filler) contents were investigated and optimized according to the JIS K6806-2003 standard.
Findings—A whey-protein based API adhesive was developed which had 28 h-boiling-dry-boiling wet compression shear strength 6.81 MPa and dry compression shear strength 13.38 MPa beyond the required values (5.88 and 9.81 MPa, respectively) for structural use of commercial standards. The study also indicated that the thermal denaturation of 40% WPI solution at 60-63° C. could unfold the globular structure of whey protein to some extent and therefore improve the bond strength and bond durability of whey-protein based API adhesive; the additions of PVA and nano-CaCO₃ as filler had significant effect on the bonding strength and bond durability of whey-protein based API adhesive. PVA had abundant hydroxyl groups that can interact with whey protein and react with crosslinking agent MDI. Without thermal denaturation and PVA addition, the whey-protein based API was almost unable to bear boiling-dry-boiling test for poor bond durability.
Research limitations/implications—The thermally denatured WPI solutions (40 wt %) incline towards being decayed by molds if not properly formulated.
Practical implications—Due to the good bonding strength and durability and environmentally safe, the optimized whey-protein based API adhesive shows greater potential for commercial applications, especially for the structural wood bonds.
Originality/value—A novel API wood adhesive for structural use was developed using whey proteins that are often regarded as a waste due to their relatively small molecules and compact globular structures.

The aqueous polymer solution-isocyanate (API) adhesive is an environmentally friendly one used to bond wood for both structural and non-structural applications. This adhesive has a relative lower cost compared with other structural adhesive such as resorcinol-formaldehyde (RF) resin and polyisocyanate resin; and is environmentally safe due to no releases of free phenol, free formaldehyde, and organic solvents. API is a two-component adhesive system composed of water-based glue and isocyanate crosslinking agent. Typically, the water-based glue is poly vinyl alcohol (PVA) solution and the mixtures of PVA with PVAc emulsion, styrene-co-butadiene rubber (SBR) emulsion, ethylene-co-vinyl acetate (EVA) emulsion, or their mixtures. The isocyanate crosslinking agent is commonly a crude form of polymeric methylene diphenyl diisocyanate (p-MDI or MDI).

Whey protein is readily soluble in water and form a homogenous solution with concentration up to 40% by weight. Whey proteins have some functional groups that are reactive to MDI (mainly residual amino groups, hydroxyl groups and thiol groups) so that whey proteins can be crosslinked by MDI to increase its molecular weight and finally form a network structures after curing. This chemical crosslink is expected to result in good bonding strength and bond durability that are necessary requirements of wood bonding for structure uses. Therefore, the present study will focus on the development of whey-protein based API adhesive for structural wood application.

### Materials

NZMP whey protein isolate (WPI) was purchased from Fonterra Ltd. (New Zealand) with protein content 92.4%. Polyvinyl alcohol (PVA) was purchased from Celanese Ltd. (Texas, USA) with degree of hydrolysis 98.0-98.8% and molecular weight about 65000.

Polymeric MDI was purchased from HUNTSMAN Polyurethane (Texas, USA) with NCO weight content 31.4%. Polyvinyl acetate (PVAc) was purchased from HEXION Specialty Chemicals (Ohio, USA) with solid content 55%. Nano-calcium carbonate, HG-01, was purchased from Shanghai Huijing Sub-nanoseale New Materials Co. Ltd (Shanghai, China) with particle size less than 40 nm. Other chemicals were reagent grade and purchased from Fisher Scientific (New Jersey, USA) or ACROS Organic (New Jersey, USA) or MP Biomedicals LLC. (Ohio, USA). All these materials were used as received.

### Thermal Denaturation of WPI

The WPI was dissolved in water at 40-49° C. to form a solution with 40 wt % concentration. The solution was then heated at 60-80° C. for various times (15-55 min) for thermal denaturation. The solution was then cooled down and stored at ambient temperature. To investigate the effect of PVA on bond properties of whey-based API adhesive, some PVA solution was introduced into WPI solution during denaturation.

### Preparation of Whey-Protein Based API Adhesives

The mixture of 70 wt % denatured WPI solution and 30 wt % PVAc emulsion was used as the water-based glue for API adhesive; and 15 wt % of MDI was used as crosslinking agent of API adhesive. All the mass ratios above were based on liquid basis. The PVAc emulsion was blended with MDI before blended with WPI solution to form API adhesives.

### Viscosity of Denatured WPI Solution

The denatured WPI solution was diluted with water into concentration 25 wt % then immersed into 20° C. water bath for 30 min before viscosity test with Brookfield Digital Viscometer DV-II+ (Maryland, USA).

### Wood Bonding

Wood bonding performance of the adhesive was evaluated by the wet and dry compression shear bond strength at breakage and the percentage of wood failure according to JIS K6806-2003 Standard: Water based polymer-isocyanate adhesives for woods. The wood adherent pieces were birch (Betula platyphylla Suk.) with dimensional size 30 mm length (fibre direction)×25 mm width×10 mm thickness. The wood pieces were moisture-conditioned at 20-23° C. and about 50% RH for more than 3 weeks.

The adhesive was applied to one length-width surface of the two pieces with coverage of approximately 200 g/m2. The wood pieces were bonded together to form a bondline with adhesive area was 25×25 mm. The bonded blocks were pressed at 1.5 kN for 2 h in Instron-5566 mechanical machine (Instron Corporation, Massachusetts, USA), and thereafter were stored at 23° C. and 50% RH for 3 days.

Because we aimed at developing a whey-protein based API adhesive for structural use, the 28-hour boiling-dry-boiling wet compression shear strengths (WCSS28h) of each adhesive were tested as follow: 1) put the bondlines into boiling water and kept boiling for 4 hours; 2) took out the boiled bondlines and put into oven preheat to 63° C. and kept for 20 h; 3) put the dried bondlines into boiling water and kept boiling for another 4 hours; 4) removed the boiling water and added cold water (10-15° C.) and kept for 30 min; 5) test the wet compression shear strength of bondlines under wet state in Instron 5566 mechanical machine with load speed 9 kN/min. The WCSS28h reflects not only the bond strength but also the bond durability of the bondline because it undergoes two 4-hour boiling treatments and a 20-hour dry treatment at 60° C. Generally, the bondline bonded with non-structural adhesives such as UF or polyvinyl acetate will be broken down after first 4-hour boiling.

Some bondlines after stored at 23° C. and 50% RH for 3 days and without 28 h boiling-dry-boiling treatment were used to determine the dry compression shear strength (DCSS) that reflects only the bond strength.

### Work Life

The work life of whey-protein based API adhesive was tested as follows: after the water-based glue (WPI/PVAc/PVA mixture or WPI/PVAc mixture) was mixed with MDI, put the mixture at 23° C. for observing the work life. The work life of API adhesive refers to the time from water-based glue mixed with MDI to the moment that the mixture can't be spread onto wood surface (not gel yet).

### Results and Discussion

### Fundamental Chemistry of Whey-Protein Based API Adhesive

Whey proteins are generally composed of linear polypeptides that were polymerized from 20 different amino acids as in Table 9 (the asparagines and glutamine were not listed). Total 10 out of 20 species of amino acids can possess not only the amino and carboxyl groups that are necessary to build in large molecular-weight polypeptides molecules but also some additional groups that are reacted to isocyano group in MDI, namely, asparagine, arginine, cysteine, glutamine, histidine, lysine, serine, threonine, tryptophan and tyrosine. The monomers that come to form linear polymer molecules need only two functional groups or two reacting sites. Therefore, the MDI-reactive groups in whey protein are from these excessive groups exclusive of one amino group and one carboxyl group in each molecule of these amino acids; they are amino groups from arginine, histidine, lysine and tryptophan, hydroxyl groups from serine, threonine and tyrosine, amide groups from asparagines and glutamine, and thiol groups from cysteine. Whey proteins are rich in the amino acids with hydroxyl groups (totally up to 17.2 g amino acids in 100 g whey protein) and excessive amino groups (totally up to 13.4 g amino acids in 100 g whey protein).

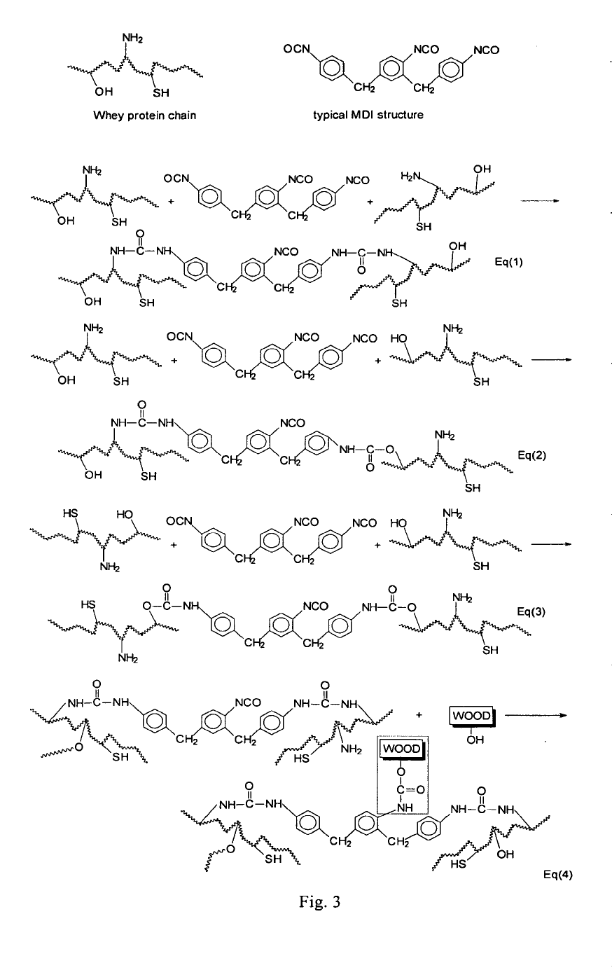

Though isocyanate can react with all groups contain “active” hydrogen atoms, such as OH, —NH2, —NH—, —NH—CO— and SH, there are three dominant WPI/MDI reactions when WPI solution is blended with crosslinking agent MDI and then cures at ambient temperature (20-25° C.) with the considerations of both the reactivity of MDI-reactive groups reacting with isocyanate and their abundances in whey proteins. These reactions were illustrated as Eq(1), Eq(2) and Eq(3) in FIG. 3, by which the whey proteins can be crosslinked by MDI to increase their molecular weights and finally form network structures after curing. The chemical crosslink can prevent the cured protein-based adhesive itself in bondline from destroying or dissolving under high-moisture and/or wet conditions, and therefore improve the internal cohesion and bond durability of whey-protein based adhesive so that the whey-protein based API adhesive can meet the necessary requirements for structure uses. During the crosslinking reactions, the isocyano groups in MDI will also react with the hydroxyl groups in wood and form urethane linkage (the chemical bond), as show in Eq(4), which further increased the bond strength and bond durability of the bondline.

TABLE 9
The residual amino acids and compositions in whey protein
(McDonough et al., 1974)

| | Composition | Additional MDI- |
|---|---|---|
| Amino acid | (g/100 g protein) | reactive groups |
| alanine | 5.15 | |
| arginine | 3.25 | 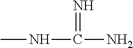 |
| aspartic acid | 11.68 | |
| cysteine | 2.36 | —CH₂—SH |
| glutamic acid | 17.28 | |
| glycine | 2.26 | |
| histidine | 2.15 | 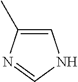 |
| isoleucine | 5.75 | |
| leucine | 12.32 | |
| lysine | 10.32 | —CH₂—NH₂ |
| methionine | 2.11 | |
| phenylalanine | 3.85 | |
| proline | 4.79 | |
| serine | 5.15 | —CH₂—OH |
| threonine | 5.83 | 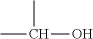 |
| tryptophan | 2.58 | 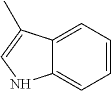 |
| tyrosine | 3.23 | 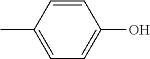 |
| valine | 6.13 | |

### The Effects of Denaturation Temperature and Time

Due to the globular structure of whey proteins, their structure must be unfolded for releasing the hidden or bonded polar groups so that the protein can be more efficiently and firmly attached to the solid surface of adherends by adsorption. Thermal denaturation under gentle conditions will not only unfold partially the globular structures of whey protein for releasing the polar groups but also offers additional cohesion strength of the adhesive via keeping the inherent intermolecular disulfide linkages. Meanwhile, the proper denaturing conditions will also prevent the whey proteins from gelling during thermal denaturation and result in a good fluid or wettability of whey-protein based adhesive on wood surfaces when spreading. Without the unfolding, the globular proteins mostly formed compact layer or sometimes rigid particle via adsorption (Norde and Favier, 1992; Haynes and Norde, 1995) which would lead to poor interface strength or bond strength during adhesion.

However, Parris and Baginski (1991) confirmed by reversed-phase HPLC that whey protein started denaturing at about 40° C. and became more rapid at 70° C. Qi and co-workers (1997) also indicated that the thermal denaturation of β-lactoglobulin at neutral and alkaline pH values shows a pronounced dependence on protein concentration. The thermal denaturations of various concentrations of WPI solutions at various temperatures were investigated. We found that the WPI solution with concentration more than 15 wt % should only be denatured at temperature less than 65° C.; otherwise the WPI solution can be gelled before or soon after it reaches the denaturing temperature. For example, the WPI solution with 40 wt % concentration will be gelled when the system temperature is just heated to be 78° C.; and the 10 wt % WPI solution can be denatured at 85° C. without gelation for 30 min or more. Therefore we selected the denaturing temperature at 60-63° C., and investigated the effects of denaturing time on the properties of 40 wt % WPI solution.

Table 10 presented that the viscosity of denatured WPI was increased sharply with denaturing time increased, indicating that more and more gels formed during thermal denaturation. When the denaturing time was more than 35 min, the texture became particle-like coagula due to the too many heat-induced crosslinks. The work time in Table 10 also sharply reduced when denaturing time more than 35 min due to obvious heat-induced gelation of WPI.

Table 10 showed that the wet bond strength of wood bondline with whey-protein based adhesives increased with denaturing time increased from 15 to 45 min and then decreased with further increase of denaturing time. The WPI denatured at 60-63° C. for 25 min has result in much better wet bond strength (3.50 MPa) than that without denaturing (0.35 MPa) or that denatured for 15 min (1.03 MPa), indicting that the globular structure of WPI has been unfolded to almost maximum. However, the further denaturing at 60-63° C. led to slight increase or even decrease on wet bond strength due to the heat-induced gelation of WPI. With the considerations of viscosity, texture and wet bond strength, we will denature 40% WPI solution at 60-63° C. for 25-35 min in further study.

TABLE 10
The properties of WPI and API adhesive with various denaturing times

| | | | Work | | Wood |
|---|---|---|---|---|---|
| Denaturing | | | time | WCSS_{28 h} | failure |
| time (min) | Viscosity | Appearance | (hour) | (MPa) | (%) |
| 0 | 47.1 | Homogeneous, | 2.6 | 0.35 | 5 |
| | | cream-like, | | | |
| | | very good fluid | | | |
| 15 | 84.3 | Homogeneous, | 2.5 | 1.03 | 50 |
| | | cream-like, | | | |
| | | very good fluid | | | |
| 25 | 90.4 | Homogeneous, | 2.5 | 3.50 | 45 |
| | | cream-like, | | | |
| | | very good fluid | | | |
| 35 | 178.1 | Homogeneous, | 2.3 | 3.70 | 60 |
| | | cream-like, | | | |
| | | good fluid | | | |
| 45 | 2564 | Many particle- | 1.4 | 3.74 | 70 |
| | | like coagula, | | | |
| | | poor fluid | | | |
| 55 | 6173 | Many particle- | 1.1 | 3.21 | 40 |
| | | like coagula, | | | |
| | | poor fluid | | | |

### The Effects of Polyvinyl Alcohol

The lower bond strength and durability of the API adhesive prepared with the blends of denatured WPI, PVAc emulsion and MDI implied that the molecules of whey proteins might not have sufficient reactive groups to be crosslinked by MDI to form a network with sufficient crosslinking density. Polyvinyl alcohol (PVA) is composed of the repeating —CH2-CH(OH)— units that are rich in hydroxyl groups that can react with MDI; besides, the PVA solution itself is a good adhesive to wood bonding. Therefore, 8.5 wt % of the polyvinyl alcohol (PVA) with molecular weight about 65000 was introduced (solid PVA/solid WPI) into WPI solution in current study by following processes:

Process I—Denaturing WPI/PVA mixture at 60-63° C. for 25 or 35 min.
Process II—Denaturing 40% WPI solution at 60-63° C. for first period (25 or 35 min) and then added PVA solution and denatured at about 50° C. for another 10 min (Labeled as 25+10 or 35+10).
Process III—Denaturing 40% WPI solution at 60° C. for a period (25 or 35 or 45 min) and then added PVA solution and well blending, after then immediately cooled down.

Srinivasa and co-workers (2003) had confirmed that the PVA will be crosslinked with protein via hydrogen bond. Lacroix and co-workers (2002) also thought that PVA is crosslinkable to whey protein. Therefore, the denatured PVA/WPI mixtures with various denaturing processes possessed various stabilities, fluids (in terms of viscosity) and textures due to the crosslinking interactions between PVA and WPI for various PVA/WPI interacting times, as shown in Table 11. The viscosities of the denatured PVA/WPI mixtures prepared with process I, II and III were decreased correspondingly, i.e., M3>M2>M1, and M6>M5>M4. In terms of the same total denaturing time being 35 min, the viscosity of the mixture with Process I (M6, 5289 cP) was larger than that with Process II (M2, 1220 cP) that in turn larger than that with Process III (M4, 1100 cP). The PVA/WPI mixtures denatured with process I had poor textures and all gelled in two days, while others had good fluids and could be stored for more than one week.

TABLE 11
The properties of WPI/PVA and API adhesives with various
denaturing processes

| | | Dena- | | | | Wood |
|---|---|---|---|---|---|---|
| | Dena- | turing | Viscosity | | | fail- |
| | turing | time | (cP, | Appearance of | WCSS₂₈ₕ | ure |
| ID | process | (min) | 20° C.) | denatured WPI | (MPa) | (%) |
| M1 | Process | 25 | 889.3 | Homogeneous, | 2.78 | 55 |
| | III | | | cream-like, good | | |
| | | | | fluid | | |
| M2 | Process | 25 + 10 | 1220 | Homogeneous, | 4.62 | 35 |
| | II | | | cream-like, good | | |
| | | | | fluid | | |
| M3 | Process | 25 | 2879 | Homogeneous, | 3.88 | 40 |
| | I | | | good fluid but | | |
| | | | | gelled in 2 days | | |
| M4 | Process | 35 | 1100 | good fluid, a few | 4.29 | 65 |
| | III | | | coagula | | |
| M5 | Process | 35 + 10 | 1150 | Many particle- | 4.26 | 60 |
| | II | | | like coagula, | | |
| | | | | good fluid | | |
| M6 | Process | 35 | 5289 | Homogeneous, | | |
| | I | | | poor fluid, but | 4.21 | 60 |
| | | | | gelled in 2 days | | |
| M7 | Process | 45 | 1130 | Many particle-like | 4.02 | 55 |
| | III | | | coagula, fluid | | |

Wood bonding tests showed that the PVA/WPI mixture denatured for 25+10 min according to Process II resulted in the best bond strength (M2, 4.62 MPa), though it was still much lower than the required value in JIS K6806-2003 Standard (5.88 MPa) for structural use. Compared the wet bond strength in Table 11 with that in Table 10, the whey-protein based API adhesives prepared with PVA/WPI mixtures were generally better than those without PVA addition. This confirmed that the addition of PVA had positive effects on the bond durability of whey-protein based API adhesives resulted from the interactions between PVA and WPI.

We further investigated the effects of various PVA contents (0, 3.75, 7.5, 11.25, 15.0 and 18.75%, solid PVA/solid WPI) on the properties of the API adhesives based on the PVA/WPI denaturing Process II for 25+10 min. But the Process II was slightly adjusted as follows: the WPI/PVA mixture was again heated to and kept at 60-63° C. (instead of 50° C.) for another 10 min after PVA solution post-added into WPI solution that denatured at 60-63° C. for 25 min. This slight adjustment resulted in that the viscosity of denatured PVA/WPI mixture (2471 cP) was much high than that before adjusting (M2, 1220 cP), as shown in Table 12 and Table 11, because of stronger interaction of PVA/WPI at higher temperature. With PVA content increased, the viscosity of PVA/WPI mixture increased gradually, for PVA had larger molecular weight and much high viscosity under the same concentration than that of WPI.

TABLE 12
The properties of WPI/PVA and API adhesives with various
PVA contents

| | | | | | Wet state | |
|---|---|---|---|---|---|---|
| | | | | | (28 h boiling- | |
| | | | Dry state | | dry-boiling) | |
| PVA | Viscosity | | | Wood | | Wood |
| content | (cP, | Work time | Strength | failure | Strength | failure |
| (%) | @ 20° C.) | (hour) | (MPa) | (%) | (MPa) | (%) |
| 0 | 178.1 | 2.3 | 6.02 | 60 | 3.70 | 60 |
| 3.75 | 2238 | 1.2 | 10.66 | 65 | 3.92 | 75 |
| 7.50 | 2471 | 2.0 | 10.56 | 80 | 5.65 | 65 |
| 11.25 | 3075 | 2.6 | 9.26 | 35 | 4.65 | 55 |
| 15.00 | 3253 | 3.1 | 7.42 | 30 | 4.65 | 85 |
| 18.75 | 3473 | 3.3 | 7.84 | 85 | 5.22 | 65 |

When the PVA contents in PVA/WPI mixtures increased from 0% to 7.5%, the 28 h boiling-dry-boiling wet strength increased from 3.70 to 5.65 MPa; further increasing the PVA content, the wet bond strength was decreased, which was attributed to the dilution of PVA solution to solid content of adhesive. Because the PVA was introduced by means of 15 wt % solution, the more PVA content in PVA/WPI mixture resulted in the more water introduced, and therefore the less solid adhesive component between the bondlines under the same resin consumption. The dry strength almost correlated with the amount of PVA introduced, directly reflected the effects of PVA dilution for the dry strength decreased from 10.66 MPa gradually to 7.84 MPa when PVA increased from 3.75 wt % to 18.75 wt %. Though the whey-protein based API prepared with WPUPVA mixture contained 7.5 wt % PVA had better 28 h boiling-dry-boiling strength, 5.65 MPa, it was still a little lower than the required value (5.88 MPa) in JIS K6806-2003.

### The Effects of Nano-CaCO₃ Contents

Mechanical properties of adhesives may be significantly improved with the addition of nano-scale filler (Chen et al., 2004; Gilbert et al., 2003) because of the large surface area of the nano-scale filler and the ability of the filler to mechanically interlock with the polymer (Hussain et al., 1996). To further improve the bond strength and bond durability, various amounts of nano-scale CaCO₃ powders (0, 5, 10 and 15 wt %, solid CaCO₃ on liquid basis of denatured PVA/WPI mixture) were introduced into the WPI/PVA mixture that denatured with Process II and contained 7.5 wt % PVA with violent mechanical stirring (1200-1500 rpm).

The addition of nano-scale CaCO₃ powder resulted in increases of bond strength and bond durability of the whey-protein based API adhesive. When the nano-CaCO₃ content was 5 wt %, the API adhesive had the best 28 h boiling-dry-boiling wet strength (6.81 MPa) that was more than the required value (5.88 MPa) in JIS K6806-2003 standard and 20.5% more than that without nano-CaCO₃ filler (5.65 MPa). When the nano-CaCO3 content was 10 wt %, the API adhesive had the best dry strength (14.34 MPa) that was much more than the required value (9.81 MPa) in JIS K6806-2003 standard and 35.8% more than that without nano-CaCO₃ filler (10.56 MPa). Further increase the nano-scale CaCO₃, both dry and wet bond strengths were sharply decreased because the viscosity was too high to be evenly spread onto wood. Therefore, addition of 5-10 wt % of nano-CaCO₃ powder into the WPI/PVA mixture that denatured with Process II and contained 7.5 wt % PVA produced whey-protein based API adhesive with good bond strength and bond durability that both meet the demands in JIS K6806-2003 standard.

In order to confirm the applicability of the optimized whey-protein based API adhesive, a commercial API adhesive that is composed of 55 wt % of PVAc emulsion, 10 wt % of SBR emulsion, 25 wt % of 15 wt % PVA solution, 10 wt % of nano-CaCO₃ and 15 wt % of MDI as crosslinking agent was used to bond wood pieces under the same bonding process and testing process. The test results showed that the commercial API adhesive had dry bond strength of 12.98 MPa and wet bond strength 6.37 MPa, as presented in Table 13, which indicated that the bond strength and bond durability of the optimized whey-protein based API adhesive was slightly better than that of the commercial API adhesive. Therefore the optimized whey-protein based API adhesive will have potential for commercial applications, especially for the structural wood bonds.

TABLE 13
The bond strengths of API adhesives with various nano-CaCO₃ contents

| | |
|---|---|
| | Wet state |
| | (28 h boiling- |
| Dry state | dry-boiling) |

| Nano-CaCO₃ | Strength | Wood | Strength | Wood |
|---|---|---|---|---|
| content (%) | (MPa) | failure (%) | (MPa) | failure (%) |
| 0 | 10.56 | 80 | 5.65 | 65 |
| 5 | 13.38 | 80 | 6.81 | 80 |
| 10 | 14.34 | 80 | 6.12 | 85 |
| 15 | 8.99 | 70 | 4.01 | 90 |
| Commercial | 12.98 | 100*¹ | 6.37 | 75 |
| API adhesive | | | | |

Note 1: All specimens were wood splitting, not bondline destroyed.

### The Effect of Blending Processes

We also investigated the effects of blending process of WPI/PVA/MDI. The WPI used was denatured at 60-63° C. for 25 min. The test results in Table 14 indicated the whey-protein based adhesive prepared with new blending process had much better WCSS28h but worse work time than that prepared using the common process. This difference may be attributed to the MDI distribution in WPI/PVAc mixture. Enough emulsifier was added during manufacturing PVAc emulsion for PVAc doesn't dissolve in water. In addition, the WPI is a special emulsifier so that we often observed many foams formed in the container that once held WPI during washing, for WPI molecule is composed of polar hydrophilic groups (such as amino groups, carboxyl, hydroxyl, etc.) and hydrophobic main chain. When WPI blended with PVAc in the common process, the emulsifier in PVAc emulsion would be exchanged with WPI to form a more stable emulsion; and the WPI molecules were wrapped by emulsifier. The wrap prevented some WPI molecules from both reacting with MDI added subsequently and adhering to wood surface. As a result, the whey-protein based adhesive prepared with common blending process had a work time prolonged 44.0% while wet bond strength decreased 63.2% compared with those with new blending process. When MDI blended with PVAc emulsion in new process, the hydrophobic MDI entered into PVAc micelles and wrapped by emulsifier. After WPI added into MDI/PVAc mixture the MDI immediately reacted with WPI during the exchange of WPI and emulsifier.

TABLE 14
The properties of API adhesives with various blending processes

| | | Work time | WCSS_{28 h} | Wood failure |
|---|---|---|---|---|
| Blending process | Adhesive Color | (h) | (MPa) | (%) |
| Common process | Yellow | 3.6 | 1.26 | 65 |
| New process | Very light | 2.5 | 3.42 | 65 |
| | yellow | | | |

These interactions can be confirmed by the colors of WPI/MDI/PVAc mixtures. In common blending process, the MDI distributed on surfaces or between the WPI/PVAc micelles, resulting in the color of WPI/MDI/PVAc mixture being yellow (note that the color of MDI is dark brown and WPI is light yellow). In new blending process, the MDI was wrapped by emulsifier and WPI, resulting in very light yellow color of the mixture.

Based on the fact that whey-protein based API with this blending process had much high wet bond strength (3.42 MPa) that was still much lower than the required value in JIS K6806-2003 Standard for structural use (5.88 MPa), the new blending process was used in further study.

### Conclusions

The thermal denaturation of 40% WPI solution at 60-63° C. could unfold the globular structure of whey protein to some extent and therefore improve the bonding strength of whey-protein based adhesive. Based on the effects of denaturation time and temperature, WPI/PVA denaturing processes, PVA contents and Nano-CaCO₃ content on the properties of denatured WPI and performances of API adhesives, a whey protein-based environmentally friendly API adhesive was developed with a dry compression shear strength 13.38 MPa and a 28 h boiling-dry-boiling wet compression shear strength 6.81 MPa. This API adhesive has the potential to be used in solid wood bond for structural uses. The addition of PVA and the adding procedure had significant effect on the bonding strength and bond durability of whey-protein based API adhesive because the PVA had abundant hydroxyl groups that can interact with whey protein and react with crosslinking agent MDI. Addition of 5-10 wt % nano-scale CaCO₃ powder as a filler can further improve the bond strength and bond durability that both meet the demands in JIS K6806-2003 standard.

### REFERENCES

Audic, J. L., Chaufer, B., and Daufin, G. (2003), “Non-food applications of milk components and dairy co-products: A review”, Lait, Vol. 83 No. 6, pp. 417-38.
Chen, H., Sun, Z., Xue, L. (2004), “Properties of nano SiO2 modified PVF adhesive”, Journal of Wuhan University of Technology—Mater. Sci. Ed., Vol. 19 No. 4, pp. 73-5
Gilbert, E. N., Hayes, B. S., Seferis, J. C. (2003), “Nano-alumina modified epoxy based film adhesives”, Polymer Engineering and Science, Vol. 43 No. 5, pp. 1096-104
Haynes, C. A. and Norde, W. (1995), “Structure and stabilities of adsorbed protein”, Journal of Colloid Interface Science, Vol. 169 No. 2, pp. 313-28
Hussain, M., Nakahira, A., Niihara, K. (1996), “Mechanical property improvement of carbon fiber reinforced epoxy composites by Al2O3 filler dispersion”, Materials Letters, Vol. 26 No. 3, pp. 185-91
Lacroix, M., Le, T. C., Ouattara, B., Yu, H., Letendre, M., Sabato, S. F., Mateescu, M. A., Patterson, G. (2002), <<Use of gama-irradiation to produce films from whey, casein and soy proteins: structure and functional characteristics”, Radiation Physics and Chemistry, Vol. 63 No. 3-6, pp. 827-32
McDonough, F., Hargrove, R., Mattingly, W., Posati, L., Alford, J. (1974), “Composition and properties of whey protein concentrates from ultrafiltration”, Journal of Dairy Science, Vol. 57 No. 12, pp. 1438-43
Norde, W. and Favier, J. P. (1992), “Structure of adsorbed and desorbed proteins”, Colloids Surface, Vol. 64 No. 1, pp. 87-93
Parris, N. and Baginski, M. A. (1991), “A Rapid Method for the Determination of Whey Protein Denaturation”, Journal of Dairy Science, Vol. 74 No. 1, pp. 58-64
Qi, X., Holt, C., Mcnulty, D., Clarke, D., Brownlow, S., Jones, G. (1997), “Effect of temperature on the secondary structure of □-lactoglobulin at pH 6.7, as determined by CD and IR spectroscopy: a test of the molten globule hypothesis”, Biochemistry Journal, Vol. 324 Pt. 1, pp. 341-46
Smithers, G. W., Ballard, F. J., Copeland, A. D., De Silva, K. J., Dionysius, D. A., Francis, G. L., Goddard, C., Grieve, P. A., Mcintosh, G. H., Mitchell, I. R., Pearce, R. J., Regester, G. (1996), “New Opportunities from the Isolation and Utilization of Whey Proteins”, Journal of Dairy Science, Vol. 79 No. 8, pp. 1454-9
Srinivasa, P. C., Ramesh, M. N., Kumar, K. R., Tharanathan, R. N. (2003), “Properties and sorption studies of chitosan-polyvinyl alcohol blend films”, Carbohydrate Polymers, Vol. 53 No. 4, pp. 431-8
Tunick, M. H. (2008), “Whey protein production and utilization: a brief history”, In Onwulata, C. I. and Huth, P. J. (Eds), Whey processing, functionality and health benefits, Blackwell, Ames, Iowa, pp. 8-9
van der Leeden, M. C., Rutten, A. A. C. M., Frens, G. (2000), “How to develop globular proteins into adhesives”, Journal of Biotechnology, Vol. 79 No. 3, pp. 211-21
Walstra, P., Geurts, T. J., Noomen, A., Jellema, A., van Boekel, M. A. J. S. (1999), Dairy Technology—principles of milk properties and processes, Marcel Dekker, New York, N.Y., pp. 80-1
Wright, N. C., Li, J., Guo, M. R. (2006). “Microstructural and mold resistant properties of environmentally-friendly oil-modified polyurethane based wood finish products containing polymerized whey proteins”, Journal of Applied Polymer Science, Vol. 100 No. 5, pp. 3519-30.

### Example 3

### Formulations and Characterization of Whey Protein Based Aqueous Polymer-Isocyanate (API) Adhesives for Structural Woods I

### Formulation and Processing Technology

A novel API adhesive for structural woods with bond strength comparable with commercial API adhesive was developed using whey protein, a byproduct of cheese making. The bond test, Fourier Transform Infrared Spectroscopy (FTIR) and Scanning Electron Microscope (SEM) were used to characterize the whey-protein based API adhesives with various formulations and processing techniques. The dry strength and the 28 h boiling-dry-boiling wet strength of the whey protein based adhesive were improved from 2.06 MPa to 13.38 MPa and from 0 to 6.81 MPa, respectively, through the introductions of crosslinker MDI, polyvinyl alcohol (PVA), nano-CaCO₃ powder and the proper blending process. The good bond strength of the optimized whey-protein based API adhesive was attributed to the strong chemical bonds existed in the bondline and to the additions of MDI, PVA and nano-CaCO₃ powder that improved adhesive cohesive strength by either chemical crosslinks or mechanical interlock; and the addition of PVA had most significant effect on the bond strength. The SEM micrographs showed that blending processes may have considerable effects on the bond strength, work life and color due to the particle size of hydrophobic MDI droplet and MDI distribution in the protein-PVA matrix.

API adhesive is a two-component system composed of water-based glue and crosslinker isocyanate. Typically, the water based glue of commercial API adhesive is poly vinyl alcohol (PVA) solution and the mixtures of PVA with PVAc emulsion, styrene-co-butadiene rubber (SBR) emulsion, ethylene-co-vinyl acetate (EVA) emulsion, or their mixtures[12]. The crosslinker isocyanate is commonly a crude form of polymeric methylene diphenyl diisocyanate (p-MDI or MDI). Compared with other structural adhesives, API adhesive is relatively inexpensive and environmentally safe, and is widely used to bond wood for both structural and non-structural applications.

The bond strength of the API adhesive prepared from whey protein was greatly affected by its processing technologies. Therefore, the effects of formulation and processing technology on bond strength of whey-protein based API adhesives were investigated in this study.

### Materials

Whey protein isolate (WPI) was purchased from Fonterra Ltd. (New Zealand) with protein content of 92.4%. Whey protein solution (40 wt %) was prepared before use. Polyvinyl alcohol (PVA) was purchased from Celanese Ltd. (Texas, USA) with degree of hydrolysis 98.0-98.8% and molecular weight about 65,000; dissolve in water to form 15 wt % solution before use. Polymeric MDI was purchased from HUNTSMAN Polyurethane (Texas, USA) with NCO weight content 31.4% and functionality 2.8. Polyvinyl acetate (PVAc) was purchased from HEXION Specialty Chemicals (Ohio, USA) with solid content 55%. Nano-calcium carbonate, HG-01, with particle size less than 40 nm, was purchased from Shanghai Huijing Sub-nanoseale New Materials Co. Ltd (Shanghai, China). Styrene butadiene rubber (SBR) emulsion was purchased from BASF Chemical Company (Ludwigshafen, Germany) with solid content 53.6%. Unless stated otherwise, the materials were used as received without further treatments.

### Preparation of Whey Protein Based API Adhesives

Total of 7 API adhesives were prepared and labeled as A 1, A2, A3, A4, A5, A6 and A7. The weight ratio of crosslinker MDI to water-base glue (as shown in Table 15) was 3/20 on liquid basis. When blended these components into API adhesives, two blending processes were applied as follows:

Process I—thoroughly mixed all components of water-base glue then thoroughly blended with MDI;
Process II—thoroughly blended PVAc with MDI then thoroughly blended with other components showed in Table 15.

Regarding to the API adhesive from A1 to A2, 40 wt % WPI solution was thermally denatured at 60-63° C. for 35 min. As for the API adhesives from A4 to A6, the WPI solution was thermally denatured at 60-63° C. for 25 min then 20 wt % of PVA solution (based on WPI solution) was added and kept at 60-63° C. for another 10 min. As for the API adhesives A5 and A6, the nano-CaCO₃ powder was added into the denatured WPI/PVA mixture at about 25° C. The adhesive A7 is a commercial API used as a control.

TABLE 15
Composition of the water-base glues for API adhesives and their blending
processes

| | The ingredients and the contents | |
|---|---|---|
| Adhesive | (wt % on liquid basis) | Blending |
| ID | of the water-based glues | process |
| A1 | Denatured WPI (100%) | Process I |
| A2 | Denatured WPI (70%) + PVAc (30%) | Process I |
| A3 | Denatured WPI (70%) + PVAc (30%) | Process II |
| A4 | Denatured WPI (58.3%) + PVA (11.7%) + PVAc | Process II |
| | (30%) | |
| A5 | Denatured WPI (55.4%) + PVA (11.1%) + | Process II |
| | CaCO₃ (3.5%) + PVAc (30%) | |
| A6 | Denatured WPI (55.4%) + PVA (11.1%) + | Process I |
| | CaCO₃ (3.5%) + PVAc (30%) | |
| A7 | PVAc (54%) + PVA (24%) + SBR (11%) + | Process II |
| | CaCO₃ (11%) | |

### Wood Bonding Performance

Wood bonding performance of the adhesives was evaluated by the wet and dry compression shear bond strength at breakage according to JIS K6806-2003 Standard: Water based polymer-isocyanate adhesives for woods. The wood adherent pieces were birch (Betula platyphylla Suk.) with dimensional size 30 mm length (fiber direction)×25 mm width×10 mm thickness. The wood pieces were moisture-conditioned at 20-23° C. and about 50% RH for at least 3 weeks.

The adhesive was applied to one length-width surface of the two pieces with coverage of approximately 200 g/m2. The wood pieces were bonded together to form a bondline with adhesive area was 25×25 mm. The bonded blocks were pressed at 1.5 kN for 2 h using Instron-5566 mechanical machine (Instron Corporation, Massachusetts, USA), and thereafter were stored at 23° C. and 50% RH for 3 d.

In order to develop a whey-protein based API adhesive for structural use, the 28-h boiling-dry-boiling wet compression shear strengths (WCSS28h) of each adhesive were tested as follow: 1) put the bondlines into boiling water and kept boiling for 4 h; 2) took out the boiled bondlines and transferred to an oven preheated to 63° C. and kept for 20 h; 3) submerged the dried bondlines into boiling water and kept boiling for another 4 h; 4) removed the boiling water and added cold water (10-15° C.) and kept for 30 min; 5) test the wet compression shear strength of bondlines under wet state with Instron 5566 mechanical machine with load speed 9 kN/min. The WCSS28h reflects not only the bond strength but also the bond durability of the bondline because it underwent two 4-h boiling treatments and a 20-h dry treatment at 60° C.

Some bondlines after stored at 23° C. and 50% RH for 3 d and without 28 h boiling-dry-boiling treatment were used to determine the dry compression shear strength (DCSS) that reflects only the bond strength.

### Work Life

The work life of whey-protein based API adhesive was tested as following: after the water-based glue mixed with MDI, the mixture was put into a chamber at 23° C. and 50% RH for observing the work life. The work life of API adhesive refers to the time from water-based glue mixed with MDI to the moment that the mixture can't be spread onto wood surface.

### FTIR Analysis

The samples selected for FTIR observation were freeze dried at −58° C. and 15 kPa for a week. The dried sample was mixed with KBr crystal at a weight ratio of about 1/150 then ground well, after that pressed in a special mold to form a FTIR sample folium, and finally scanned using a Magna IR560 FTIR instrument (Nicolet Co., USA). The IDs and components of FTIR samples were summarized in Table 16. Before freeze drying, samples from B4 to B7 were cured at ambient for 7 d after the water-base glue mixed with MDI.

TABLE 16
IDs and composition of the FTIR samples

| Sample ID | Components |
|---|---|
| B1 | WPI solution without denaturing (freeze dried) |
| B2 | Denatured WPI solution (freeze dried) |
| B3 | Denatured WPI/PVA mixture (from adhesive A4-A5, freeze |
| | dried) |
| B4 | Cured resultant of adhesive A1 at ambient for 7days |
| B5 | Cured resultant of the mixture of PVA and MDI at ambient |
| | for 7days |
| B6 | Cured resultant of adhesive A3 at ambient for 7days |
| B7 | Cured resultant of adhesive A4 at ambient for 7days |

### SEM Analyses

The SEM was employed to observe the bulk morphologies of adhesive before cured. The SEM samples were prepared as follows. Drop fresh liquid adhesive into liquid nitrogen and kept for 5 min, then immediately put the quick-frozen adhesive drops into freeze drier that was adjusted to be −55° C., and freeze dried at −50° C. and 15 Pa for 5 d. The dried adhesive drops were put into liquid nitrogen immediately for quenching. Fractured the just-quenched adhesive drops and took a piece from fractured surface of the adhesive drop for SEM examination.

The SEM samples were coated with approximately 10-20 nm of gold before examination with a QUANTA-200 SEM (FEI Co., USA) with a working distance of about 10 mm at 12.5 kV.

### Results and Discussion

Bond Strength of the API Adhesives with Various Preparing Processes

Whey proteins are soluble in water to form a homogeneous “solution” with concentration more than 40 wt %. Due to their low molecular weight compared with other proteins such as soybean protein[9] and its good water solubility, whey protein alone serve as wood adhesive could not yield good bond strength and any bond durability, as indicated by the test results of Adhesive A0 (40 wt % WPI “solution” only without crosslinker MDI) in Table 17. Its bond strength mainly came from the bond mechanism involving both the adsorption of polar groups (amino, hydroxyl, amide, carboxyl, etc.) of whey protein on wood surface and the mechanical interlocking between solid protein (binder) and porous wood (substrate). The dry bond strength (DCSS) was only 2.06 MPa, which was the lowest among the all whey-protein based adhesives and far below from the required value (9.81 MPa) for structural use according to the JIS K6806-2003 Standard. Most of samples for wet strength test (or bond durability evaluation) could not bear 28 h boiling-dry cycle and yielded almost no wet strength that indicated very poor bond durability.

TABLE 17
Performances of whey-protein based adhesives prepared with various
formulations

| Adhesive | Work life | | Strength (MPa) | |
|---|---|---|---|---|
| ID | (h) | Adhesive color | DCSS | WCSS_{28 h} |
| A0 | N/A | Light yellow | 2.06 | ≈0 |
| A1 | 0.5 | Light yellow | 5.78 | 2.64 |
| A2 | 3.6 | Yellow | 5.46 | 1.32 |
| A3 | 2.3 | Very light yellow | 6.02 | 3.70 |
| A4 | 2.0 | Very light yellow | 10.56 | 5.65 |
| A5 | 2.1 | Yellowish-white | 13.38 | 6.81 |
| A6 | 2.5 | Light yellow | 11.42 | 4.54 |
| A7 | 2.8 | Light yellow | 12.98 | 6.37 |

Note:
The Adhesives from A1 to A7 were the mixture of MDI and water-base glue in Table 16, respectively; while Adhesive A0 was just the 40 wt % of denatured WPI solution (at 60° C. for 35 min) as control.

Whey proteins are rich in the amino acids with hydroxyl groups (up to 0.11 mol per 100 g whey protein) and residual amino groups (up to 0.13 mol per 100 g whey protein)[10], which are very reactive to and suspected to be able to be crosslinked by MDI as illustrated by Eq. (1) and Eq. (2). Therefore, MDI (15 wt %, liquid basis) was added into WPI “solution” as a crosslinker in Adhesive A1 that was the prototype of the novel whey-protein based API adhesive in order to improve the bond strength. The crosslinking reaction resulted in the increase of both molecular weight and crosslinking densities of whey protein, by which improved the cohesive strength of final API adhesive. Besides, not all isocyano groups were consumed in crosslinking reaction as indicated by the FTIR analysis; certain remaining isocyano groups could react with the active groups on wood surface and therefore formed powerful chemical (or covalent) bonding via urethane bridge between the adhesive and wood, as illustrated by Eq. (3). All these endowed the adhesive A1 with much better bond strength (5.78 MPa) and bond durability than the control (A0), as presented in Table 17. The wood bondline of this API adhesive could not only bear 28 h boiling-dry cycle but also yielded a wet strength (WCSS28h) of 2.64 MPa.

However, the work life of adhesive A1 was very short, about 0.5 h, because the whey proteins have abundant residual amino groups that are very reactive to isocyano group; soon after mixed WPI solution with MDI, the adhesive became very viscous and formed many particle-like accumulates due to the formation of insoluble polyurea chains and the quick increase of molecular weight unevenly for the reactions of amino with isocyano groups, as illustrated by Eq. (1). In order to improve the work life, PVAc emulsion (30 wt %, liquid basis) was introduced into WPI solution to reduce the reacting rate by diluting. The adhesive A2 was prepared by the blending Process I that PVAc emulsion was mixed with WPI solution prior to mixing with MDI; while the adhesive A3 was prepared by the blending Process II that PVAc was mixed with MDI before mixing with denatured WPI solution. The test results in Table 17 indicated that the work lives of whey-protein based API adhesives were obviously improved after introducing 30 wt % of PVAc emulsion regardless of the blending process of WPI, PVAc and MDI. The blending Process II produced an API adhesive (A3) with shorter work life (2.3 h), lighter color (very light yellow) and much better wet strength (3.70 MPa) compared with the API adhesive (A2) prepared by blending Process I (with work life 3.6 h, yellow color, and wet strength 1.32 MPa). However, their dry bond strengths were comparable (6.02 vs. 5.46 MPa). These comparisons implied that the blending processes of WPI, PVAc and MDI had significant effect on the performances of final API adhesives.

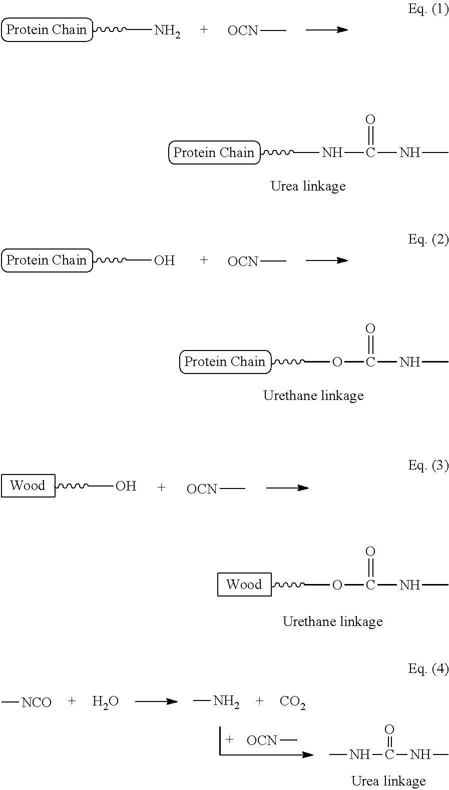

Polyvinyl alcohol (PVA) is composed of the repeating —CH2-CH(OH)— units that are rich in hydroxyl groups that can react readily with MDI; it is the reason that the PVA solution is chosen as one of the most common water-based glue in commercial API adhesives. In addition, it was reported that the PVA is crosslinkable to whey protein[13-14]. Therefore, 0-20 wt % of PVA solution was introduced into the water-based glue of adhesive A3 (liquid basis) and obtained a new series of water-based glues (i.e., adhesive from A4-0 to A4-4 in Table 18) with expectation to improve the bond strength via increasing the crosslinking density of API adhesive. The results of bond tests in Table 17 and Table 18 showed that both dry strength and wet strength of resulted API adhesives increased gradually with PVA content increased until PVA content 11.7% (adhesive A4 in Table 17 or A4-2 in Table 18), and then decreased with further increase of PVA content. The dry strength (10.56 MPa) and wet strength (5.65 MPa) of adhesive A4 (or A4-2) were the best among these adhesives, with 75.4% and 52.7%, respectively, higher than those of adhesive A3 without PVA addition. This confirmed that the proper amount of PVA could effectively increase the crosslinking density of final cured adhesive via the linkages of PVA with both WPI and MDI, and resulted in significantly improving the bond strength. According to the commercial standard for structural use, the dry strength of adhesive A4 was beyond the required value (9.81 MPa), while the wet strength was still slightly lower than the required value (5.88 MPa).

TABLE 18
Bond strength of API adhesives prepared with various contents of PVA
and nano-CaCO₃

| Adhesive | The ingredients and the contents (wt % | Strength (MPa) | |
|---|---|---|---|
| ID | on liquid basis) of the water-based glues | DCSS | WCSS_{28 h} |
| A4-0 | Denatured WPI (70%) + PVA (0%) + | 6.02 | 3.70 |
| (A3) | PVAc (30%) | | |
| A4-1 | Denatured WPI (63.6%) + | 10.66 | 3.92 |
| | PVA (6.4%) + PVAc (30%) | | |
| A4-2 | Denatured WPI (58.3%) + | 10.56 | 5.65 |
| (A4) | PVA (11.7%) + PVAc (30%) | | |
| A4-3 | Denatured WPI (53.8%) + | 9.26 | 4.65 |
| | PVA (16.2%) + PVAc (30%) | | |
| A4-4 | Denatured WPI (50%) + PVA (20%) + | 7.42 | 4.65 |
| | PVAc (30%) | | |
| A5-0 | Denatured WPI (58.3%) + | 10.56 | 5.65 |
| (A4) | PVA (11.7%) + CaCO₃ (0%) + | | |
| | PVAc (30%) | | |
| A5-1 | Denatured WPI (55.4%) + | 13.38 | 6.81 |
| (A5) | PVA (11.1%) + CaCO₃ (3.5%) + | | |
| | PVAc (30%) | | |
| A5-2 | Denatured WPI (53%) + | 14.34 | 6.12 |
| | PVA (10.6%) + CaCO₃ (6.4%) + | | |
| | PVAc (30%) | | |
| A5-3 | Denatured WPI (50.7%) + | 8.99 | 4.01 |
| | PVA (10.1%) + CaCO₃ (9.2%) + | | |
| | PVAc (30%) | | |

Mechanical properties of adhesives may be significantly improved with the addition of nano-scale filler[15-18] because of the large surface area of the nano-scale filler and its ability to interlock mechanically with the polymer[17]. In these studies, 0-9.2 wt % of nano-scale CaCO₃ powder was introduced, with vigorous mechanical stirring (1200-1500 rpm), into the water-based glue in adhesive A5. The results in Table 18 showed that both dry strength and wet strength increased at first and then decreased with the nano-filler content increased from 0 to 9.2%. Higher levels of nano-filler made the API adhesive too viscous to be blended and hard to spread onto wood. The best level of nano-scale CaCO₃ powder was 3.5%, by which obtained an API adhesive (A5) with 28 h boiling-dry-boiling wet strength (6.81 MPa) that was more than the required value (5.88 MPa) in JIS K6806-2003 standard and 20.5% more than that without nano-CaCO₃ filler (5.65 MPa). The dry strength (13.38 MPa) of API adhesive A5 was also much higher than the required value (9.81 MPa) of JIS K6806-2003 standard and 26.7% higher than that without nano-CaCO₃ filler (10.56 MPa).

Adhesive A6, with the same components as A5 but prepared with another blending process (Process I), yielded a dry bond strength of 11.42 MPa and wet strength of 4.54 MPa that were 14.6% and 33.3% lower than that of adhesive A5, respectively. This again confirmed that the blending process had great impact on the bond strength of API adhesive. This effect will be further discussed.

Adhesive A7 was a commercial API adhesive for structural use. This water-based glue is composed of 54 wt % of PVAc emulsion, 11 wt % of SBR emulsion, 24 wt % of PVA solution and 11 wt % of nano-CaCO₃ (liquid basis). The results showed that the commercial API adhesive had dry bond strength of 12.98 MPa and wet bond strength 6.37 MPa. The results indicated that the whey-protein based API adhesive A5 had comparable bond strength with the commercial API adhesive and therefore it showed a potential for commercial applications for the structural wood bonds.

### FTIR Analysis

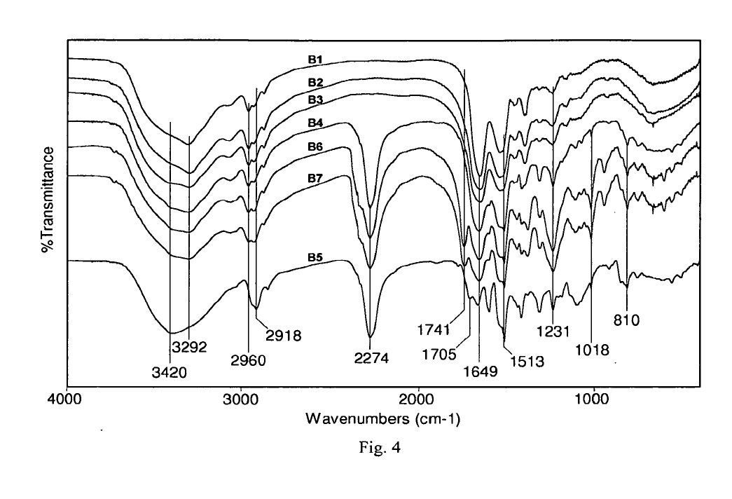

Infrared spectroscopy is one of the well-established experimental techniques for qualitative analyses of the organic substances including the polymers. The FTIR spectra of the water-based glues and cured resultants of whey-protein based API adhesives were presented in FIG. 4. In the spectra of WPI only (B1 and B2), the main IR bands were detected at about 3420 (assigned to O—H stretching), 3292 (N—H stretching), 2960-2918 (C—H stretching), 1649 (C═O stretching), 1531 (N—H bending coupled with CN stretching), 1396 (N—H bending coupled with CN stretching) and 1231 cm-1 (NH bending plus CN stretching). Compared B1 (WPI without denaturing) with B2 (denatured WPI), their IR spectra were quite similar to each other, indicating that the thermal denaturation of WPI at 60° C. for 35 min had no obvious effect on the chemical compositions. However, the viscosity of denatured WPI (concentration 25 wt % at 20° C.) was 178.1 mPa·s, 3.78 times as much as that of WPI solution without denaturing (47.1 mPa·s), implying that thermal denaturation led to some changes in the advanced structures of whey proteins. The changes were generally resulted from the unfolding of globular protein molecules and a small quantity of polymerizations of whey proteins via intermolecular thiol/disulfide interchange reactions[18-19]. These structural changes during thermal denaturation were hard to be detected directly by IR spectroscopy. Due to the fact that the whey protein contains considerable amount of hydroxyl groups[10], the IR spectrum of denatured WPI/PVA mixture (B3) also exhibited quite similar with that of WPI only (B1 or B2) except some increases of IR transmittance at about 3420 cm-1 that was attributed to the OH stretching of added PVA.

As for the cured resultants (B4, B6 and B7) of some water-based glues mixed with crosslinker (MDI), their IR spectra were quite similar and could detect the main bands at about 3420 (assigned to O—H stretching), 3292 (N—H stretching), 2960-2918 (C—H stretching), 2274 (residual —N═C═O of MDI), 1737 (stretching mode of C═O in PVAc), 1649 (stretching mode of C═O in both protein and the urea derived from MDI), 1531 (N—H bending coupled with CN stretching), 1396 (N—H bending coupled with CN stretching), 1231 (NH bending plus CN stretching), 1018 (C—O—C stretching in the ester group of PVAc) and 810 cm-1 (bending mode of C—H in p-substituted benzene ring of MDI).

In the mixture of 100 g of PVA solution with 15 g of MDI (the sample B5), the MDI reacted not only with water to form urea linkage as illustrated as Eq. (4), but also with the hydroxyl in the PVA to form urethane linkage that can be illustrated by the reactions as Eq. (2) or Eq. (3). As a result, the IR spectrum of B5 detected a strong peak at about 1649 cm-1 assigned to the C═O stretching mode of urea and a middle-strong peak at about 1705 cm-1 assigned to the C═O stretching mode of urethane. However, the FTIR didn't detect the C═O stretching mode of urethane at about 1705 cm-1 in the cured mixture of WPI solution with MDI (sample B4); this FTIR observation indicated that the crosslinking reaction of whey protein by MDI was mainly carried out via the reaction of NCO with residual amino group, not with hydroxyl, though the amino and hydroxyl groups are the two most abundant MDI-reactive groups in whey proteins[10]. In other words, the FTIR confirmed that the reaction illustrated in Eq. (2) was not the main crosslinking reaction when WPI solution mixed with MDI because the reactivity of NCO/amino reaction is much higher than that of NCO/hydroxyl reaction.

The reaction of —NCO with either water or the residual amino in the protein formed urea linkage, as illustrated in Eq. (4) and Eq. (1), respectively. The IR absorption of C═O stretching of urea linkages ranged from 1670-1630 cm-1 that was overlapped with that of protein (1649 cm-1)[20]. As a result, the IR spectra could not distinguish the C═O stretching of urea from that of protein.

Though the reaction rates of MDI with water and amino groups are much faster, the FTIR spectra still detected the existence of considerable free —NCO groups (bands at about 2274 cm-1) in the cured mixtures of water-base glue with MDI (at ambient for 7 d). This implied that the quantity of the NCO that could be used to chemically bond wood via the reaction as illustrated in Eq. (3) in API adhesive was much more than that we observed in IR spectra, because the API adhesive in practice must be used up after the water-base glue mixed with MDI in 2-3 h and the bonding reaction synchronized with the curing reaction after the API adhesive spread onto wood surface. Consequently, the bond strength of API adhesives involved the chemical bonding reaction of NCO groups (adhesives from A1 to A6) were improved to great extent compared with that of adhesive A0 without MDI as crosslinker, as shown in Table 17.

### SEM Examination

It has been noticed that the blending processes of WPI “solution”, PVAc emulsion and MDI had great effects on the performances of whey-protein based API adhesives (A2 vs. A3, and A5 vs. A6 in Table 17). It is assumed that the effects were mainly resulted from the various mass dispersions in the API adhesives due to the different compatibilities between WPI (solution), PVAc (emulsion) and MDI (oil-like liquid). Therefore the SEM was employed to investigate the mass dispersions (via observing the bulk morphologies) of the mixtures of WPI, PVAc and/or MDI with various preparing processes.

With attempt to observe natural bulk morphology of adhesive frozen quickly by liquid nitrogen (without dehydration), an environmental SEM (ESEM) was employed. However, the ESEM could not give the acceptably clear photos because of serious discharging resulted from the poor electric conductivity of frozen adhesive sample. In order to avoid the discharging and obtain a surface with morphology represented that of bulk adhesive, the fresh liquid adhesive was dropped into liquid nitrogen for quickly and deeply freezing all molecules in adhesive, then the frozen adhesive drops were dehydrated by freeze dryer at below −50° C. for 5 d, after then quenched in liquid nitrogen and immediately made a brittle fracture to the quenched dry drops, and finally coated 10-20 nm of gold on the observing surface for electric conductivity.

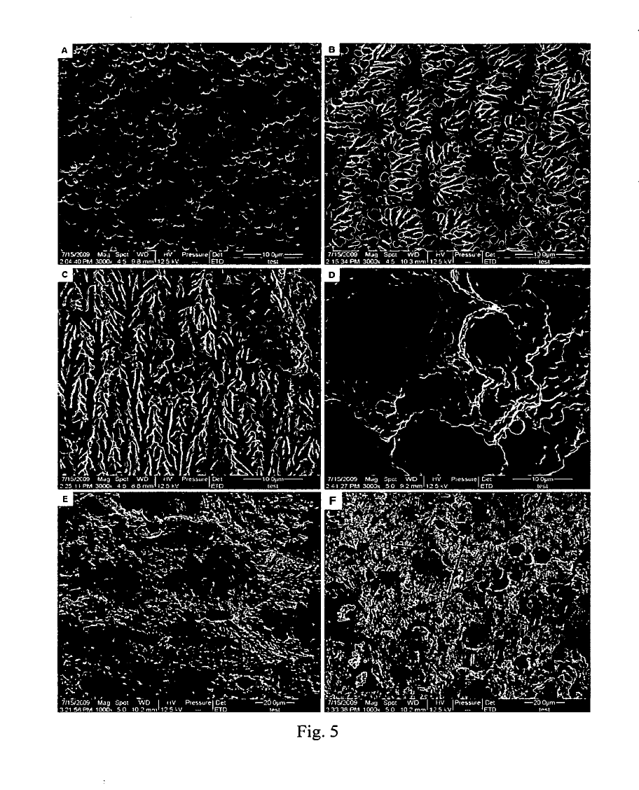

After the quick freezing by liquid nitrogen and freeze dry, FIG. 5A displayed the natural bulk morphology of PVAc emulsion. The aggregated PVAc micelles with diameter ranged from 1 to 5 μm remained their spherical shapes and kept discerning after dehydration. This confirmed that the process of quick freezing by liquid nitrogen combined with freeze dry is applicable to detecting the natural bulk morphology of some emulsion or “solution” by SEM. Both PVA and WPI are soluble in water and PVA are crosslinkable to WPI[13-14], the liquid WPI/PVA blend came to be a homogeneous “solution” and therefore we could not distinguish PVA from WPI in the dehydrated resultant, as shown in FIG. 5B. This could confirm the good compatibility of PVA with WPI. The continual honeycomb structures in FIG. 5B indicated that WPI/PVA blend with solid content of 38.3 wt % was not real solution but a colloid disperse system due to the larger molecular weight and self-emulsifying capabilities of both PVA and WPI.

When PVAc emulsion blended with WPUPVA blend, the final mixture assumed an “island-sea” structure, as shown in FIG. 5C. The PVAc micelles didn't disperse evenly and separately within WPUPVA blend but clustered to form some “islands” with size ranged from 5 to 30 μm due to the hydrophobicity of PVAc molecules. The PVAc micelles in the island still remained their ball shapes and kept discerning, which were the same as those in FIG. 5A (for PVAc only).

When PVAc emulsion blended with crosslinker MDI, the active MDI immediately reacted with both water and the active components in emulsion (mainly the polyvinyl alcohol as protective colloid[21]). The reaction of MDI and water released carbon dioxide gas and therefore there were many bubbles within the PVAc/MDI mixture, as shown in FIG. 5D. Both PVAc and MDI are hydrophobic so that MDI molecules are compatible with PVAc micelles in the presence of emulsifier that kept hydrophobic PVAc molecules being dispersed relatively stably within water. Besides, some protective colloids in PVAc emulsion were out of work after their reaction with MDI. As a result, some PVAc-micelle clusters were broken and then syncretized with the MDI and MDI derivatives, which formed a complete entity with the unbroken PVAc-micelle clusters embedded in.

FIG. 5E showed the bulk morphology of dehydrated WPI/PVA/PVAc/MDI mixture prepared with blending Process I (blended WPI/PVA with PVAc before blending with MDI). The PVAc micelles also clustered and dispersed as “islands” in WPUPVA matrix, as showed in FIG. 5C (for WPI/PVA/PVAc mixture). However, some micelles were syncretized with the MDI and MDI derivatives, as shown by the arrows “a”, and showed the morphologies as those in FIG. 5D (for PVAc/MDI mixture); while some micelles were not syncretized, as shown by the arrows “b”, and showed the morphologies as those in FIG. 5C (for WPI/PVA/PVAc mixture). The syncretized PVAc-micelle clusters were observed on the fractured surface of adhesive drop, indicating that there was no or weak interacting forces between PVAc-micelle clusters and WPI/PVA matrix. In addition, we could find the impressed marks of broken bubbles resulted from the MDI-water reaction in WPUPVA matrix, as shown by the arrows “c”.

FIG. 5F showed the morphology of the dehydrated WPI/PVA/PVAc/MDI mixture prepared with blending Process II (blended PVAc with MDI before blending with WPI/PVA). The PVAc micelles were all syncretized with the MDI and MDI derivatives, as shown by the arrows “d”, and showed the morphologies as those in FIG. 5D. Many bubbles that were resulted from the MDI-water reaction were found in either PVAc-micelle clusters or WPI/PVA matrix, as shown by the arrows “e”.

Compared with FIG. 5E with the same magnification, there were much more PVAc-micelle clusters and bubbles in FIG. 5F, indicating that the MDI distributed more evenly in adhesive prepared with blending Process II. It was also confirmed by the light colors of adhesives prepared with blending Process II than that of prepared with blending Process I (Adhesive A3 vs. A2, and A5 vs. A6 in Table 17). Because MDI is dark brown while WPI solution is light yellow and PVAc emulsion and CaCO₃ powder are white in colors, the colors of the mixtures depended on the distribution of MDI for the MDI contents in adhesives were kept the same. The differences of MDI distribution and adhesive color related to the adhesives prepared with various blending processes were attributed to the hydrophobicity of MDI and the blending mechanisms as follows. In the blending Process II, MDI blended firstly with PVAc emulsion that contains emulsifier, resulting in even dispersion of the hydrophobic MDI in PVAc emulsion; after that the MDI/PVAc mixture was further dispersed in WPI/PVA matrix. As a result, the MDI could be distributed more evenly in WPI/PVA matrix in the followed blending, because the MDI has been “diluted” in advance by the PVAc emulsion which led to a larger mass ratio of the mixing, (MDI+PVAc)/(WPI+PVA)=0.64. In the blending Process I that the PVAc was blended with WPI/PVA matrix before blending with the hydrophobic MDI, the MDI was hard to be evenly distributed in WPI/PVA/PVAc matrix because of the less mass ratio of the mixing, MDI/(WPI+PVA+PVAc)=0.15.

With the combination of the hydrophobicity of MDI and the MDI distribution discussed above, the difference in the color of adhesive further implied that the hydrophobic MDI droplets had larger particle size in adhesives prepared with blending Process I than those prepared with blending Process II. Larger particle size of hydrophobic MDI droplet resulted in less contacting areas with water, WPI and PVA in final adhesive, which consequently reduced the reacting rate of MDI and led to longer work lives of adhesives prepared with blending Process I. Meanwhile, the MDI droplets with uneven distribution and larger particle size in adhesive could not adequately crosslink both whey proteins and PVA molecules as much as possible for formation of larger-molecular-weight adhesive resultant with stronger cohesive strength. As a result, the dry- and wet strength of adhesive prepared with blending Process I were not as good as those with blending Process II, as showed in Table 17.

### Conclusion

A whey protein based API formulation (Adhesive A5) with bond strength comparable to a commercial API adhesive for structural use was developed. According to commercial standard (JIS K6806-2003), the adhesive had a 28 h boiling-dry-boiling wet strength 6.81

MPa and a dry strength 13.38 MPa. The blending procedures of WPI, PVA, PVAc and MDI had great impacts on the performances of the whey protein based API adhesives. The addition of crosslinker MDI increased the cohesive strength of the cured adhesive by crosslinking both whey protein and PVA and it also resulted in strong chemical bonds (urethane linkage) in adhesive-wood bondline via the reaction of residual NCO group with hydroxyl on wood surface. The addition of PVA further increased the crosslinking density of the cured adhesive by its capability of crosslinking whey protein and reacting with MDI. The nano-scale CaCO₃ markedly improved the bond strength because its mechanical interlocks with the polymers in the adhesive. SEM micrographs of the adhesives revealed that PVA had good compatibility with whey proteins; and the effects of blending process on the performance of API adhesive were attributed to the particle size of hydrophobic MDI droplet and the uniformity of MDI distribution in the WPI/PVA matrix.

### REFERENCES

[1] Tunick M. H. Whey protein production and utilization: a brief history; In: Onwulata C. I.; Huth P. J. (Eds). Whey processing, functionality and health benefits; Ames, USA: Blackwell, 2008
[2] Audic J. L.; Chaufer B.; Daufin G. Lait, 2003, 83, 417
[3] Smithers G. W.; Ballard F. J.; Copeland A. D.; De Silva K. J.; Dionysius D. A.; Francis G. L.; Goddard C.; Grieve P. A.; Mcintosh G. H.; Mitchell I. R.; Pearce R. J.; Regester G. Journal of Dairy Science, 1996, 79, 1454
[4] Wright N.; Li J.; Guo M. Journal of Applied Polymer Science, 2006, 100, 3519
[5] Tharanathan R. N. Trends in Food Science & Technology, 2003, 14: 71-78
[6] Le Tien C.; Letendre M.; Ispas-Szabo P.; Mateescu M. A.; Delmas-Patterson G.; Yu H.-L.; Lacroix M. Journal of Agricultural and Food Chemistry, 2000, 48, 5566
[7] Zhao R.; Torley P.; Halley P. J. Journal of Materials Science, 2008, 43, 3058
[8] Walstra P.; Geurts T. J.; Noomen A.; Jellema A.; van Boekel M. A. J. S. Dairy Technology-principles of milk properties and processes; New York, USA: Marcel Dekker, 1999
[9] van der Leeden M. C.; Rutten A. A. C. M.; Frens G. Journal of Biotechnology, 2000, 79, 211
[10] McDonough F.; Hargrove R.; Mattingly W.; Posati L.; Alford J. Journal of Dairy Science, 1974, 57, 1438
[11] Gao Z.; Yu G.; Bao Y.; Guo M. Pigment and Resin Technology, 2010, Accepted for publication
[12] Hori N.; Asai K.; Takemura A. Journal of Wood Science, 2008, 54, 294
[13] Lacroix M.; Le T. C.; Ouattara B.; Yu H.; Letendre M.; Sabato S. F.; Mateescu M. A.; Patterson G. Radiation Physics and Chemistry, 2002, 63, 827
[14] Srinivasa P. C.; Ramesh M. N.; Kumar K. R.; Tharanathan R. N. Carbohydrate Polymers, 2003, 53, 431
[15] Chen H.; Sun Z.; Xue L. Journal of Wuhan University of Technology—Mater. Sci. Ed., 2004, 19(4), 73
[16] Gilbert E. N.; Hayes B. S.; Seferis J. C. Polymer Engineering and Science, 2003, 43, 1096
[17] Hussain M.; Nakahira A.; Niihara K. Materials Letters, 1996, 26, 185
[18] Monahan F. J.; German J. B.; Kinsellat J. E. Journal of Agricultural and Food Chemistry, 1995, 43, 46
[19] Qi X.; Holt C.; Mcnulty D.; Clarke D.; Brownlow S.; Jones G. Biochemistry Journal, 1997, 324, 341
[20] Litvinov V. M.; De P. P. Spectroscopy of Rubber and Rubbery Materials; Shropshire, UK: Rapra Technology Limited, 2002
[21] Nakamae M.; Yuki K.; Sato T.; Maruyama H. Colloids and Surfaces A: Physicochemical and Engineering Aspects, 1999, 153, 367

### Example 4

### Physicochemical Properties of Whey Protein-Based Safe Paper Glue

Commercial paper glue products on the market may contain toxic organic compounds harmful to people and bad for the environment. In order to develop safe paper glues, whey protein-based glue prototypes were formulated using polymerized whey proteins (PWP) and other ingredients. Bonding strength, one of main indexes for glue products, was evaluated, along with the physicochemical properties of the prototypes compared with a commercial control sample. Reconstituted whey protein isolate (WPI) solution (10%, pH 7.0) was polymerized at 75° C. for 15 min. The polymerized whey protein (PWP) was combined with PVA, (20%, w/w), emulsifier (propylene glycol) and antibacterial agent (1,2-Benzisothiazolin-3-one). The best ratio of PWP solution to PVA solution was about 1.7 to 1.0 with 0.5% propylene glycol and 0.2% 1,2-Benzisothiazolin-3-one. The experimental and control glues were sealed in plastic containers and held in an environment controlled chamber (23° C., 50% RH) for six months to determine the bonding strength and physical properties and to evaluate the shelf life. Three trials of the glue prototype were carried out and three replicates from each trial were taken for chemical analysis. The bonding strength of the glue was evaluated according to a modified ASTM procedure (D1002-05) using an Instron Universal Testing Machine. Physicochemical properties, including viscosity as well as total solids, ash and protein content, were analyzed using AOAC standard methods. The bonding strength of the glue was 221.5±5.06 N. Viscosity was 675.6±34.6 mPa·s; total solids was 14.38±0.04; ash was 0.27±0.02%; and protein was 9.15±0.07%. The bonding strength and viscosity of both whey protein-based safe paper glue and the control sample remained steady during 6-month storage.

### Example 5

### Development and Functionalities of Milk Protein-Based Paper Glue

Commercial paper glue products on the market may contain toxic compounds harmful to the people and the environment. Prototype of environmentally safe paper glues containing polymerized whey protein (PWP) and sodium caseinate were developed and optimized under a full factorial experiment design with factors of protein content, denature temperature, time and other ingredients. The prototypes were analyzed for physicochemical properties including pH value, ash contents, total solids, and viscosity, and functional properties including bonding strength, water resistance, temperature and moisture resistance. When compared with the commercial product, the prototypes had higher pH value (6.6/4.7), higher ash content (0.3%/0.1%), lower total solids (15.8%/31.2%) and higher viscosity (5975/2472 mPa), respectively. Bonding strength is considered as the main index because it is the most important property for glues. The bonding strength of the prototypes was up to 161.4 N while commercial sample was 154.6. According to the ASTM standards, the water resistance and temperature-and-moisture resistance of the prototypes were better than those of commercial samples. The statistical analyses indicated that the denaturation time had significant effects (P<0.05) on bonding strength, while both the WPI/PVA ratio and denaturation time had very significant effects (P<0.01).

### Example 6

### Develop Whey Protein Based Safe Paper Glue Stick

Experimental Design: The goal of this study was as follows:
(i) choose the best denaturation temperature for whey protein,
(ii) use an orthogonal design to optimize a paper glue formulation,
(iii) evaluate the cobinding properties of sodium caseinate and PVAC,
(iv) evaluate the effects of different process and the addition of nano calcium carbonate on the bonding strength of glue stick
(v) compare an optimal paper glue formulation and making process with the commercial glue stick

The bonding test-ASTM (American Society of Testing Materials) D906 was used to evaluate the bonding strength of the prepared prototypes. This test method covers the determination of the apparent shear strengths of adhesive for bonding papers when tested on a standard single-lap-joint specimen. The ends of the specimen are placed in the jaws of a tensile testing machine (called instron) and then separated at a chosen rate. The shear strength is recorded as bonding strength.

### I. The Effect of Denaturing Temperature

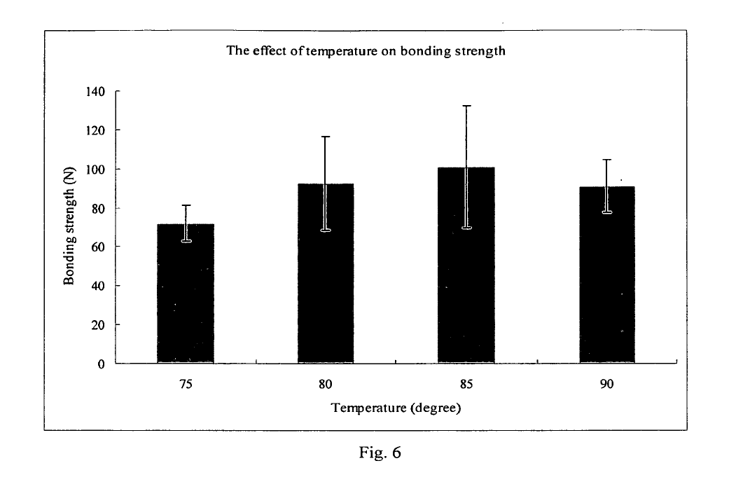

10% WPI solution was heated at 75° C., 80° C., 85° C., and 90° C. for 30 minutes, and the samples were tested for bonding strength. The whey protein denaturation temperature had no significant effect on bonding strength (P=0.498>0.05; FIG. 6).

### II. Screening Design

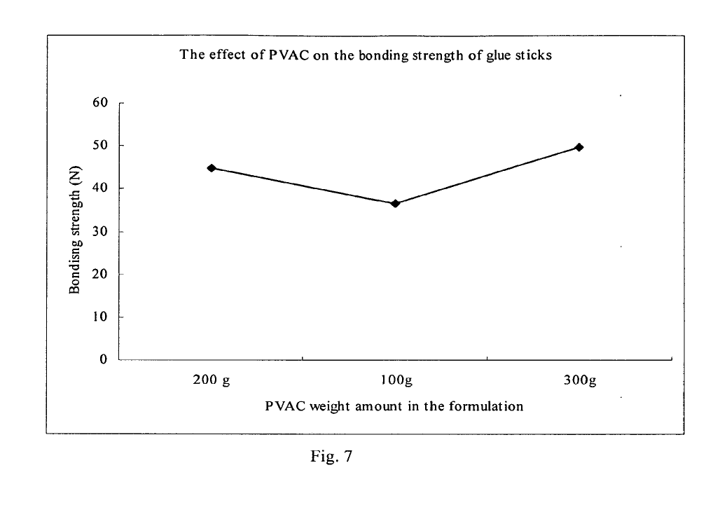

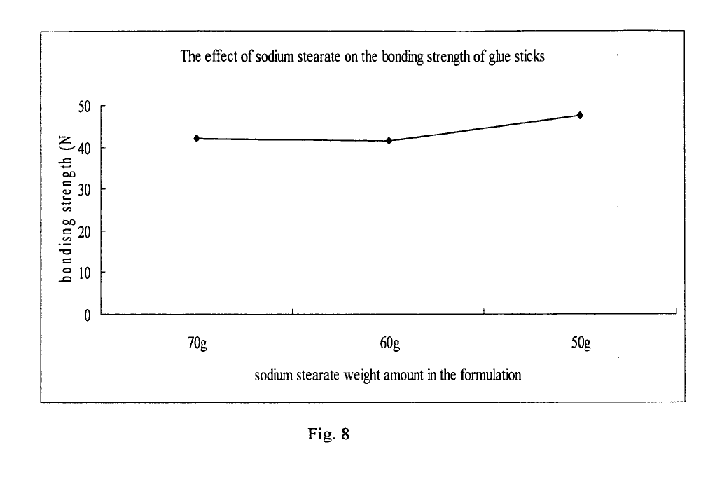

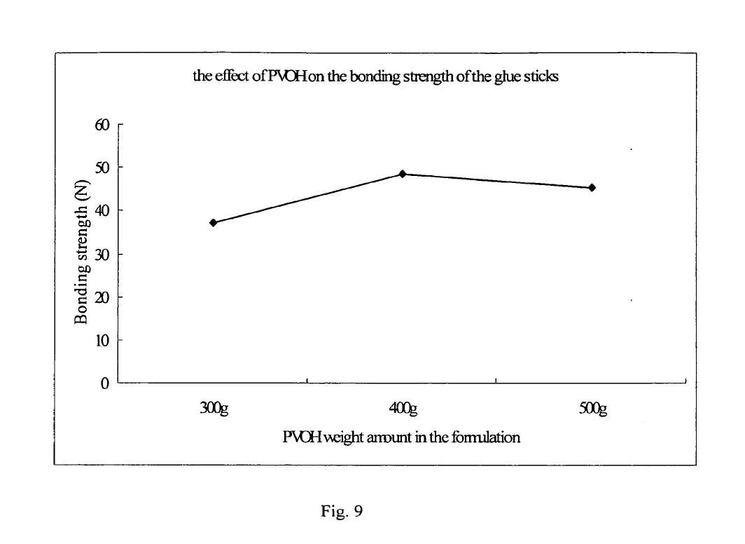

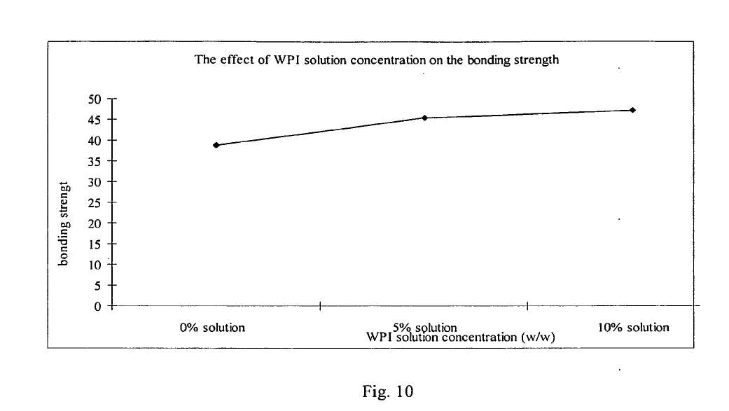

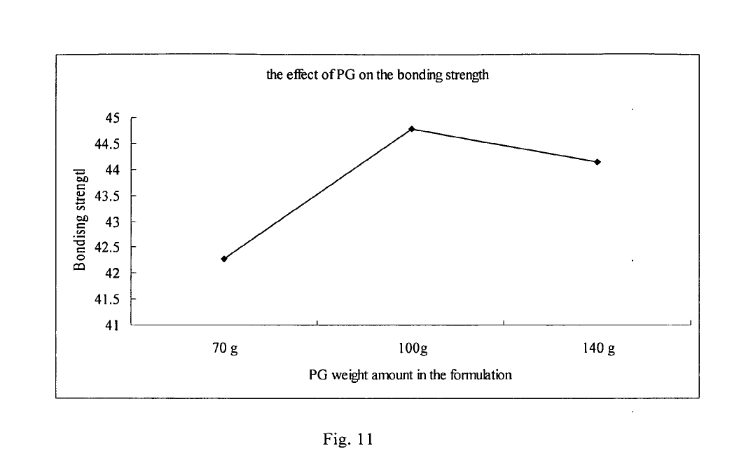

A three level orthogonal design was used to optimize the formulation (Table 19). The five factors are the amount of PVAC, sodium stearate, polyvinyl alcohol (PVOH), propylene glycol (PG) and the concentration of WPI solution concentration. For each factor, three levels were assessed. For example, for PVAC, the 1st level was 200 g, the 2nd 100 g, the 3rd 300 g, and so on. The orthogonal design in all included 27 different formulations (Table 20). Bonding strength, appearance and texture of these formulations were evaluated. Statistical analysis was performed using a main-effects ANOVA model in SPSS software. All ingredients except PG have a significant effect on the bonding strength of glue stick (FIGS. 7-11). In particular, WPI solution has a significant effect on the bonding strength of the glue stick (FIG. 10).

An example of a formulation with good bonding strength comprises:

300 g 10% WPI solution

### 400 g 20% PVOH

### 300 g PVAC

60 g sodium sterate

### 70 g PG

This optimized formulation reached the same bonding strength as the most popular glue stick on market.

TABLE 19
Five factor, three level

| | factor | | | | |
|---|---|---|---|---|---|
| | | Sodium | | | |
| level | PVAC | Stearate | PVOH(20%) | WPI(300 g) | PG |
| L1 | 200 g | 70 g | 300 g | 0% | 70 g |
| L2 | 100 g | 60 g | 400 g | 10% | 100 g |
| L3 | 300 g | 50 g | 500 g | 5% | 140 g |

TABLE 20
Screening Design

| | | | Sodium | | | |
|---|---|---|---|---|---|---|
| | Pattern | PVAC | Stearate | PVA | WPI | PG |
| S1 | −−−−− | L1 | L1 | L1 | L1 | L1 |
| S2 | −−−−0 | L1 | L1 | L1 | L1 | L2 |
| S3 | −−−−+ | L1 | L1 | L1 | L1 | L3 |
| S4 | −000− | L1 | L2 | L2 | L2 | L1 |
| S5 | −0000 | L1 | L2 | L2 | L2 | L2 |
| S6 | −000+ | L1 | L2 | L2 | L2 | L3 |
| S7 | −+++− | L1 | L3 | L3 | L3 | L1 |
| S8 | −+++0 | L1 | L3 | L3 | L3 | L2 |
| S9 | −++++ | L1 | L3 | L3 | L3 | L3 |
| S10 | 0−0+− | L2 | L1 | L2 | L3 | L1 |
| S11 | 0−0+0 | L2 | L1 | L2 | L3 | L2 |
| S12 | 0−0++ | L2 | L1 | L2 | L3 | L3 |
| S13 | 00+−− | L2 | L2 | L3 | L1 | L1 |
| S14 | 00+−0 | L2 | L2 | L3 | L1 | L2 |
| S15 | 00+−+ | L2 | L2 | L3 | L1 | L3 |
| S16 | 0+−0− | L2 | L3 | L1 | L2 | L1 |
| S17 | 0+−00 | L2 | L3 | L1 | L2 | L2 |
| S18 | 0+−0+ | L2 | L3 | L1 | L2 | L3 |
| S19 | +−+0− | L3 | L1 | L3 | L2 | L1 |
| S20 | +−+00 | L3 | L1 | L3 | L2 | L2 |
| S21 | +−+0+ | L3 | L1 | L3 | L2 | L3 |
| S22 | +0−+− | L3 | L2 | L1 | L3 | L1 |
| S23 | +0−+0 | L3 | L2 | L1 | L3 | L2 |
| S24 | +0−++ | L3 | L2 | L1 | L3 | L3 |
| S25 | ++0−− | L3 | L3 | L2 | L1 | L1 |
| S26 | ++0−0 | L3 | L3 | L2 | L1 | L2 |
| S27 | ++0−+ | L3 | L3 | L2 | L1 | L3 |

### III. The Cobinding Properties of Sodium Caseinate and PVAC

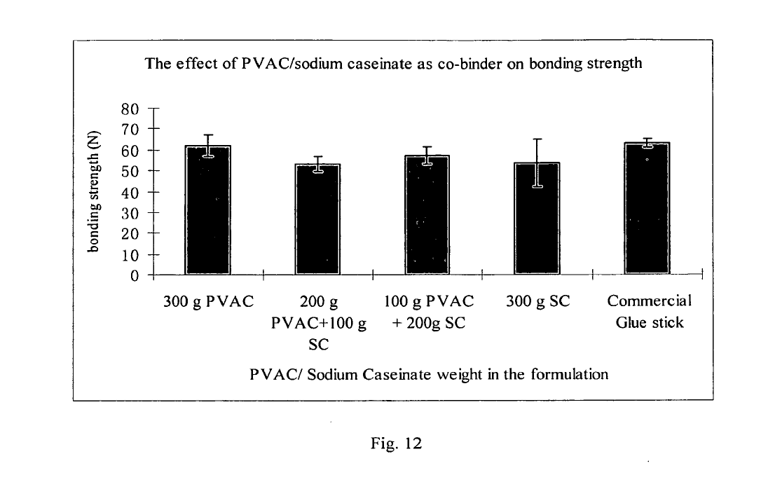

Based on the optimal formulation shown above (10% WPI 300 g, PVA 400 g, Sodium Stearate 60 g, PG 70 g), four formulations with variable amounts of PVAC/Sodium Caseinate were produced (Table 21). Results showed that substituting PVAC with sodium caseinate did not improve the bonding strength (FIG. 12).

TABLE 21
The cobinding properties of sodium caseinate and PVAC

| | Ingredients | | | | | |
|---|---|---|---|---|---|---|
| | | | sodium | | | sodium |
| Formulation | PVOH | WPI (10%) | stearate | PG | PVAC | caseinate |
| F1 | 400 g | 300 g | 60 g | 70 g | 300 g | 0 g |
| F2 | 400 g | 300 g | 60 g | 70 g | 200 g | 100 g |
| F3 | 400 g | 300 g | 60 g | 70 g | 100 g | 200 g |
| F4 | 400 g | 300 g | 60 g | 70 g | 0 g | 300 g |

### IV. The Effect of Blending Process and Nano Calcium Carbonate

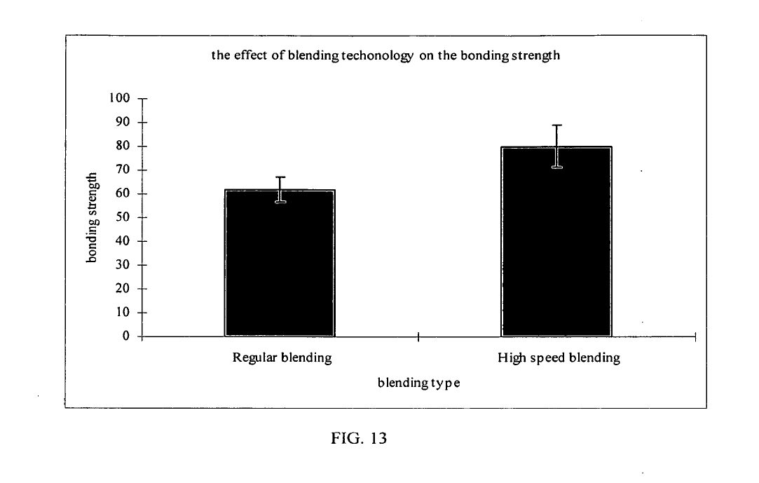

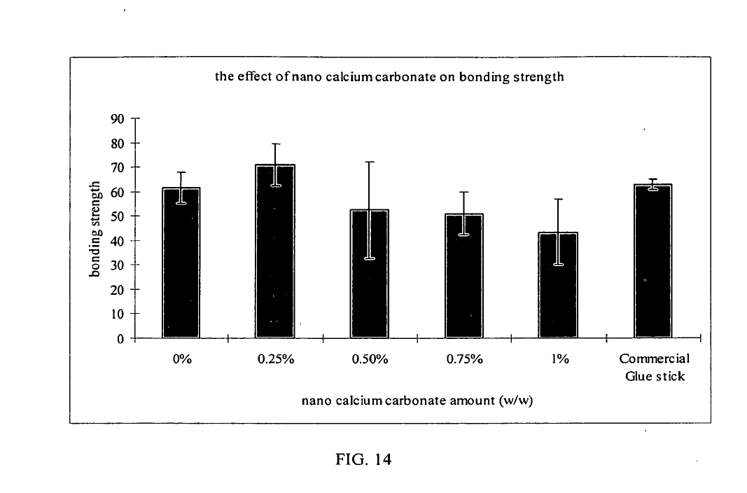

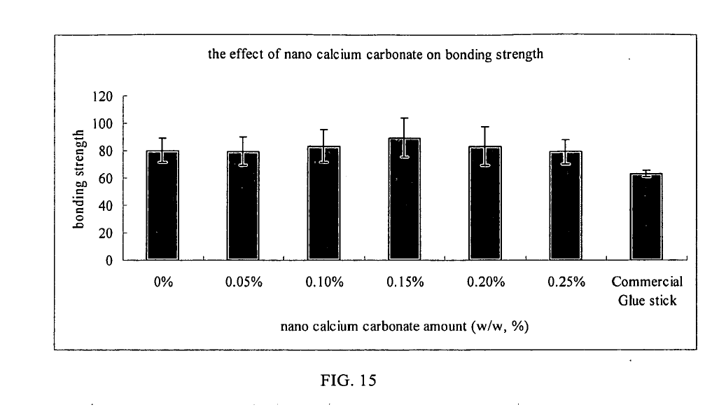

WPI solution was heated to 85° C. for 30 minutes. Next, PVOH was added to the heated WPI solution and mixture was blended for 15 minutes. Next PVAC was added to the mixture which was blended for a further 15 minutes. Sodium stearate and PG were to added to the blended mixture which was then transferred to a high speed blender. Finally nano calcium carbonate was added was the bonding strength of the formulation was tested. The bonding strength of the glue stick made by high speed blending technology was significant higher than that of regular blending technology FIG. 13). Addition of nano calcium carbonate did not significantly improve the bonding strength FIGS. 14-15).

### Example 7

### Environmentally Safe Adhesive Prepared with Whey Protein for Water-Resistant Plywood

Whey protein is a by-product of cheese processing. Lots of whey proteins are under utilized except some is used as food additives. In order to utilize the them with more value added, the paper investigated the effects of denaturation, modifier species and the content on the bond strength and the free formaldehyde release of plywood panels, by which optimized an environmentally safe whey-protein adhesive for resistant plywood. The results indicated that the denaturation improves the water resistance of the plywood panel. The modifier species had various effects on the panel performances, i.e., the adhesive modified with 1% MDI showed best water resistance while the adhesive modified with the mixture of 0.15 wt % glutaraldehyde and 1 wt % glyoxal showed best bond strength. The scale-up test confirmed that the plywood panels bonded by the whey-protein based adhesive had dry bond strength of 1.98 MPa, wet bond strength of 1.14 MPa (after 28 h boiling-dry-boiling treatment), and free formaldehyde release of 0.035 mg/L (Desiccator method). Finally the techniques of FTIR and SEM were employed to analyze the bond mechanisms of whey-protein adhesives.

It should be understood that although particular embodiments and examples of the invention have been described in detail for purposes of illustration, various changes and modifications may be made without departing from the scope and spirit of the invention. Accordingly, the invention is not to be limited except as by the appended claims.

We claim:

What is claimed is:

1. A wood adhesive solution comprising whey protein, water, a crosslinking agent, and a plasticizer, wherein the solution is a wood adhesive.

2. The wood adhesive solution of claim 1, wherein the crosslinking agent is a multifunctional isocyanate, a polyisocyanate, a pre-polymer of polyisocyanate, polyvinyl alcohol (PVA), an ethylene-vinyl alcohol, polyvinyl formal, polyvinyl butyral, or a combination thereof.

3-6. (canceled)

7. The wood adhesive solution of claim 1, wherein the plasticizer is polyvinyl acetate emulsion, an ethylene-vinyl acetate (EVA) emulsion, an ethylene-vinyl alcohol (EVAOH) emulsion, a styrene-butadiene (SB) emulsion, a styrene-butadiene-styrene (SB) emulsion, other latexes, or a combination thereof.

8. The wood adhesive solution of claim 1, wherein the solution comprises between 5-50% by weight of whey protein.

9-11. (canceled)

12. The wood adhesive solution of claim 1, wherein the whey protein is denatured whey protein.

13-14. (canceled)

15. The wood adhesive solution of claim 1, wherein the viscosity of the solution is between 100-1000 mPa at 20° C.

16. The wood adhesive solution of claim 1, wherein the solution has a dry bond strength of at least 8.5 MPa.

17. (canceled)

18. The wood adhesive solution of claim 1, wherein the solution attains a wet strength of up to 6.8 MPa when soaked in 57-63° C. water for three hours (WS3h).

19. The wood adhesive solution of claim 1, wherein the solution attains a wet strength of at least 5.65 MPa when boiled for 4 hours and dried for 20 hours and then boiled for 4 hours (WS28h).

20. The wood adhesive solution of claim 1, further comprising one or more of a filler, a pigment agent, a stabilizing agent, a defoamer, a pH-adjusting agent, a solvent, a flame retardant, a biocide, an antimicrobial agent, or a scent agent.

21-23. (canceled)

24. The wood adhesive solution of claim 1 disposed on a surface.

25. (canceled)

26. The wood adhesive solution of claim 1, disposed between two surfaces, wherein the solution, when dry, forms a bond between the surfaces.

27-44. (canceled)

45. A method of making a wood adhesive solution of claim 1, the method comprising:
mixing a denatured whey protein with a crosslinking agent and a plasticizer to produce the wood adhesive solution.

46-80. (canceled)

81. A plywood adhesive solution comprising whey protein, water, and a modifier species, wherein the solution is water resistant when dry.

82. The plywood adhesive solution of claim 81, wherein the modifier species is a multifunctional isocyanate, a polyisocyanate, a pre-polymer of polyisocyanate, polyvinyl alcohol (PVA), an ethylene-vinyl alcohol, polyvinyl formal, polyvinyl butyral, a dialdehyde, or a combination thereof.

83-85. (canceled)

86. The plywood adhesive solution of claim 81, further comprising one or more of a filler, a pigment agent, a stabilizing agent, a defoamer, a pH-adjusting agent, a solvent, a flame retardant, a biocide, an antimicrobial agent, or a scent agent.

87. The plywood adhesive solution of claim 81, wherein the solution, when dry, has a dry bond strength of at least 1.0 MPa.

88. (canceled)

89. A method of making a plywood adhesive solution of claim 81, the method comprising:
contacting whey protein, water, and a modifier species to produce the plywood adhesive solution, wherein the plywood adhesive solution is water-resistant when dry.

90-91. (canceled)

93. The method of claim 89, further comprising adding one of more of a filler, a pigment agent, a stabilizing agent, a defoamer, a pH-adjusting agent, a solvent, a flame retardant, a biocide, an antimicrobial agent, or a scent agent.

94. (canceled)

95. A wood laminate comprising wood panels bonded together by a plywood adhesive solution of claim 81.

96-101. (canceled)
